(19) United States
(12) Patent Application Publication
(10) Pub. No.: US 2009/0307763 A1
(43) Pub. Date: Dec. 10, 2009

(54) Automated Test Management System and Method

(75) Inventors: Eric Rawlins, Collegeville, PA (US); Abhijit Bhide, North Wales, PA (US); Jack Tllghman, (US)

Correspondence Address: WOLF GREENFIELD & SACKS, P.C., 600 ATLANTIC AVENUE, BOSTON, MA, 02210-2206, US

(73) Assignee: FIBERLINK COMMUNICATIONS CORPORATION, Blue Bell, PA (US)

(21) Appl. No.: 12/134,099

(22) Filed: Jun. 5, 2008

(51) Int. Cl. G06F 11/07; G06F 9/445; G06F 15/177; G06F 7/06; G06F 15/16; H04L 9/32; G06F 17/30

(52) U.S. Cl. 726/5; 714/37; 717/176; 709/221; 717/178; 707/4; 709/201; 709/202; 714/E11.002; 707/E17.016; 707/E17.044

(57) ABSTRACT

A test management application on a test management server includes a user interface on a Web-based portal by which a user can define one or more tests, selecting any desired configuration of operating system, connection type, and/or application, which are then saved in a test management database in the central server. Multiple tests involving the same configuration can be defined and saved for later selection, either individually or as a group of tests. A client agent engine on a test device can query the test management server for tests that can be conducted using the device's current configuration. If no such tests are found, the device can then query the test management server for the next available test. Upon allocation of the next available test to the device, the necessary system configuration for that test can be automatically retrieved, installed, and verified by the device. The device under test is automatically rebuilt to have the proper configuration for the test to be run.

### TECHNICAL FIELD

Aspects and features described herein relate to a system and method for automated testing of system configurations and applications on remote devices.

### BACKGROUND

The industrialized world is becoming increasingly dependent on computers and networks. While computing devices and data communications networks help make businesses and people more efficient by enabling users to obtain, process, and share information, our increasing dependency on them can also present special security challenges.

Every corporate IT network is unique to its organization, based on the industry and compliance requirements in place. With the multitude of operating systems, PCs, laptops and mobile devices available today, it is an arduous task for IT administrators to ensure that all of these machines are talking to one another and are secure. For software and technology services vendors, testing is time and labor-intensive, and the number of anticipated access and security scenarios is staggering. The bar is set even higher if the vendor specializes in mobile security where the machines protected are moving targets.

To assist in integrating multiple devices and multiple applications, several vendors provide interoperability solutions which can enable a device to coordinate the operation of multiple applications running on the device. Other solutions work to enhance the security of the devices involved from software threats such as viruses and spyware and from unauthorized access threats such as those presented by hackers or other unauthorized users.

Enterprise solutions often function primarily as an aggregator of various proprietary and third party applications, including connectivity applications, security applications, and end-user applications. For example, an enterprise solution can involve one or more application from the following set of application types:
Data Encryption
Backup and Recovery
Content Management
VPN
Firewall
Antivirus
Operating system
Connection
Interoperability

Each of these application types can have multiple options for an enterprise to choose from. For example, there can be five possible data encryption applications, three firewall applications, seven antivirus applications, and four connection applications, and any combination of these different types of applications can be running on any one device. Moreover, an enterprise can have many different devices having different combinations of these applications, such as laptop computers running one type of connectivity software and PDAs running another.

The installation, use, and maintenance of these solutions often can require that an enterprise's quality assurance and other personnel conduct many rounds of testing to ensure that these applications interoperate with one another. However, at any time, each of these applications may have multiple updates, upgrades, or new releases, and thus there can be tens of thousands of possible combinations of these applications, hundreds of which are commonplace. In addition, as new applications are introduced, interoperability with existing applications must also be verified. Thus, there can be thousands of potential test cases, each having complicated environments and configuration prerequisites. Tracking all the prerequisites and executing tests manually is inefficient and reduces overall quality. Setting up the test machine, the test environment, the test case and any other prerequisite setups are cumbersome and time-consuming tasks.

There exists no single unified end-to-end process for satisfying all of an enterprise's testing needs, including automated test machine setup, installation and configuration of applications involved in the test, test script prerequisites, test case prerequisites, test case execution, results aggregation, and results reporting. Existing solutions address only some but not all of these aspects of a testing system.

U.S. Pat. No. 6,804,709 to Manjure et al. describes a system and method for automating testing of a remote access protocol using different server-client configuration combinations. Servers and clients participating in the testing register with the test controller, which matches a server with a client based on their respective configuration capabilities. Test cases from a test database are then assigned to the server-client pair for execution. For each assigned test case, the client assumes the client configuration of that case and calls the server to establish a connection under the remote access protocol being tested, with the server assuming the server configuration for the assigned test case.

U.S. Pat. No. 7,299,382 to Jorapur describes a system and method to provide testing in different configurations automatically. A test generator that can generate one or more tests based on one or more templates is described. The tests generated can change various testing parameters such as input values, modules in the application, configuration settings, data types, communication parameters, or other application elements, and such changes can be generated automatically during testing. Deployment and undeployment of applications also may be automated for testing.

U.S. Published Patent Application No. 2007/0204071 to Bai et al. describes an apparatus, system, and method for automated device configuration and testing. Bai et al. describes receiving and implementing a configuration request sent from a host computer, receiving and executing a power cycle request sent from the host, and receiving and implementing a request from the host computer for a test using the implemented configuration.

U.S. Published Patent Application No. 2007/0234293 to Noller et al. describes a testing framework to automatically allocate, install, and verify a given version of a system under test, automatically exercise the system against a series of tests, and export the test results for analysis or other handling. In Noller et al., the client application periodically queries whether a test request has been received by the testing framework. If no test request has been received, the application cycles to the next periodic query to see if a test request has been received. If a test request has been received, the client application checks for the necessary software build for the application being tested, installs any necessary software, and executes the test. Noller et al. does not, however, describe a server component for setting up a test that can be automatically executed by a test device or the construction of a scripting engine that can execute tests, nor does it describe a test system that can test multiple applications and their interoperability.

Existing commercial products also do not provide complete solutions to the desire for an automated end-to-end testing process.

For example, Ghost Solution™ by Symantec Corporation provides central re-imaging of test devices in an enterprise. Ghost Solution™ does not permit the automatic loading of a new operating system, nor does it provide support for automatically installing new third-party applications. Changes to either the operating system baseline or any application package would require changes to each image using that OS/package.

Workstation™ and Lab Manager™ by VMWare, Inc. provide an enterprise with the ability to create one or more “virtual” computers on a single physical piece of hardware. The VMWare solutions provide a “snapshot” feature that permits the saving of a configuration of applications on a machine for future use; however, each snapshot must be separately created and saved, with the combination of applications comprising each snapshot being manually installed at that time. In addition, the creation and use of virtual machines does not expose physical hardware to applications running within the virtual machine, and so hardware such as dial modems, wireless devices, and cellular cards are not accessible from the virtual machine.

QADirector™ by Compuware Corporation provides a centralized test management application. QADirector™ is a “push” system that assigns tests to specific machines that meet the requirements of each test. This requires that the available machines and their capabilities be known and limits the ability to add machines to an existing test queue. Each test machine is static, and does not have the ability to easily change operating systems or application configurations so that it can be used for multiple tests. QADirector™ uses only Compuware's proprietary TestPartner™ testing software, and is not compatible with other scripting engines.

SilkCentral® Test Manager™ from Borland Software Corporation integrates with the VMWare Lab Manager™ discussed above. Thus, SilkCentral®, like Lab Manager™, requires the use of separate predefined machine configurations to be loaded onto test devices and lacks the ability to provide direct access to a test machine's hardware.

Thus there is a need for a solution that can manage the end-to-end automation process without manual test system configuration or application installation. A solution is needed that can allow quality assurance testers, developers, and other interested persons to easily schedule dynamic sets of test cases to execute and then, without interacting with the test machines, have the tests fully execute and present a consolidated report back to the tester. This solution needs to be able to test multiple operating systems across multiple platforms with thousands of combinations of third party application installations for interoperability testing. Each test system must be running on hardware that accurately reproduces production hardware including full non-virtualized hardware access for hardware testing.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter.

Embodiments in accordance with aspects and features described herein provide methods and systems for automated setup, configuration, management, execution, and reporting of software tests on one or more devices in an enterprise via a Web-based portal accessible to authorized persons anywhere at any time, using small reusable components that can be combined to form an entirely unattended testing framework.

An automated testing system according to aspects and features described herein includes a test management server application running on a central server and a test setup and execution client application running on one or more devices. The remote devices under test can include desktop computers, laptop computers, PDAs, or any combination thereof.

The test management application includes a user interface by which a user can define one or more tests, selecting any desired configuration of operating system, connection type, and/or application, which are then saved in a test management database in the central server. Multiple tests involving the same configuration can be defined and saved for later selection, either individually or as a group of tests.

The system operates as a “pull” rather than a “push” system, i.e., test devices do not wait to be assigned an application from the test server but instead actively seek out tests to perform. The test client application on a device can query the test management database for tests in a test queue or other actions that can be conducted using the device's current configuration and if any such tests or other actions are found, they can be automatically run on the device. If no such tests are found, the device can then query the test management database for the next available test in the test queue. Upon allocation of the next available test to the device, the necessary system configuration for that test can be automatically retrieved, installed, and verified by the device. Multiple devices can simultaneously query the test management server, and any device can do so without the need for any preconfiguration or preselection of the device since the device under test is automatically rebuilt to have the proper configuration for the test to be run.

The test results can be compiled and used by the client application to choose what action to take next. Such actions can include re-running the test, for example, if the test is incomplete or the results are inconclusive; sending the results to the test management server for review and analysis by enterprise personnel; running a new test with the same system configuration; and requesting a new test with a new configuration and starting the process all over again.

All of these steps can be performed automatically with little or no need for intervention by an operator once the tests are defined and put into the testing system, thus enabling enterprise personnel to create a fully configurable test environment in little time and with little effort.

### BRIEF DESCRIPTION OF THE DRAWINGS

FIG. 1 depicts an exemplary configuration of a test server and test devices in a test management system according to one or more aspects described herein.

FIG. 2 is a block diagram depicting an exemplary system architecture of a test management system according to one or more aspects described herein.

FIGS. 3A and 3B are block diagrams depicting an exemplary system architecture of a central server in a test management system according to one or more aspects described herein.

FIGS. 4A-4C are block diagrams depicting an exemplary system architecture of a test device in a test management system according to one or more aspects described herein.

FIG. 5 depicts an exemplary workflow for data setup in a server in a test management system according to one or more aspects described herein.

FIG. 6 depicts an exemplary workflow for setup of a test queue in a test management system according to one or more aspects described herein.

FIG. 7 depicts an exemplary master workflow for execution of a testing process in a test management system according to one or more aspects described herein.

FIG. 8 depicts an exemplary logic workflow for execution of a test queue in a test management system according to one or more aspects described herein.

FIG. 9 depicts an exemplary workflow for setup of a test machine in a test management system according to one or more aspects described herein.

FIG. 10 depicts an exemplary workflow for execution of a test script in a test management system according to one or more aspects described herein.

FIG. 11 depicts an exemplary workflow for processing test results in a test management system according to one or more aspects described herein.

FIG. 12 depicts an exemplary configuration of a test server and test devices in a distributed test management system according to one or more aspects described herein.

### DETAILED DESCRIPTION

The aspects summarized above can be embodied in various forms. The following description shows, by way of illustration, combinations and configurations in which the aspects can be practiced. It is understood that the described aspects and/or embodiments are merely examples. It is also understood that one skilled in the art may utilize other aspects and/or embodiments or make structural and functional modifications without departing from the scope of the present disclosure.

For example, aspects and features of an automated software testing system and method may at times be described herein in the context of a particular test management server application such as Fiberlink's Test Management System application, a particular test management client application such as Fiberlink's Client Agent Engine, and an automated device re-imaging and configuration tool such as Fiberlink's PC Build application. It should be noted, however, that any particular solutions, vendors, and applications described herein are merely exemplary, and that aspects and features described herein can be applied equally as well to other solutions, vendors, and applications.

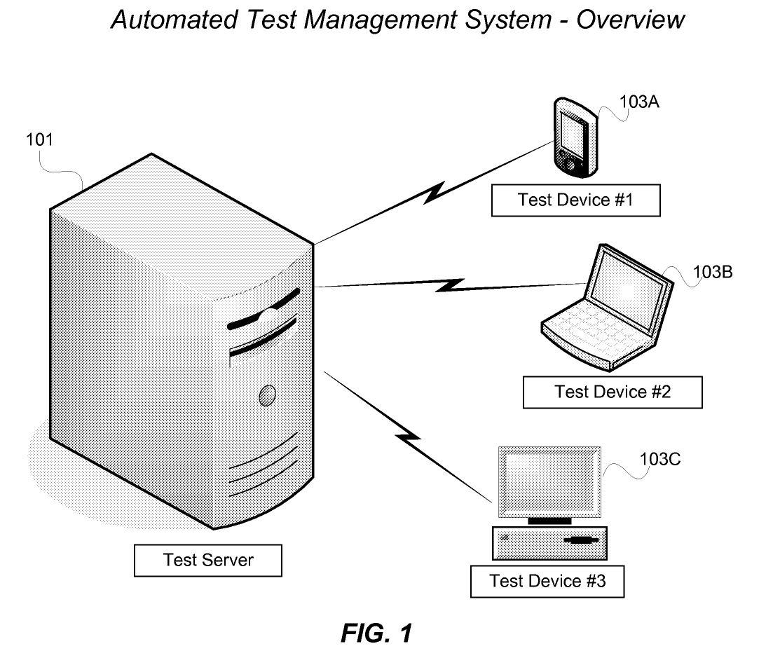

A modern enterprise can have a computer system that involves multiple devices of different types, each being connected to a central server by a different connection type, and each having different applications and/or different application versions or releases installed thereon. For example, as shown in FIG. 1, an enterprise system can include a central test server 101 and multiple remote devices, such as a PDA 103A, which communicates with the server via a cellular connection and has a first set of applications installed thereon; a laptop computer 103B, which communicates with the server via a WiFi connection and has a second set of applications installed thereon; and a desktop computer 103C, which communicates with the server via an broadband connection and has a third set of applications. Irrespective of the connection method used to communicate with test server 101, each of the devices 103A to 103C can be used to test a connectivity of the device using a particular transport mode. For example, any of devices 103A to 103C can use any type of transport to connect to other test servers to specifically test the connectivity to those servers and can use any means to connect to the test server to upload results. Although each device is said to communicate with the server, in conducting testing over different transports, the device will communicate with different servers (e.g., testing a WiFi connection will go through a WiFi router, testing a dial-up connection goes through a dialup router, testing of mobile data transport tests different cell providers, etc). At any point in time, it is important to verify conclusively that all of the applications on each device can coexist with each other and that their core functionalities are not broken due to interoperability issues.

There currently exists no single unified end-to-end process for satisfying all testing needs for such systems, needs which can include test machine setup, application installation and configuration, test script prerequisites, test case prerequisites, test case execution, results aggregation, and results reporting for any combination of device type, operating system, connection type, and application.

Thus, provided herein is a test management system (TMS) that can make any of these combinations available to enterprise personnel so that they can be tested and validated to ensure that the enterprise's devices and applications function properly, to assist in software and configuration development, or for any other enterprise purpose.

In accordance with aspects herein, a user can define one or more test cases to test connectivity, software applications or other aspects of a test device. A test case comprises a series of test steps that has one or more validation criteria and one or more pass/fail steps that can determine a test case result. For example, if a VPN client is being tested, one test case can verify whether a tunnel is established after the connection is made while another test case can verify that the tunnel is terminated when the connection is ended. Still another test case may verify that the version of the VPN client is displayed in the user interface. In accordance with aspects herein, a test case is thus the smallest testing unit of a test management system.

The user can also define one or more test suites. A test suite comprises multiple test cases that have similar characteristics, for example, because they test the same functionality, test the same application, or test the same feature, and have the same environment prerequisites. Each test case belongs to a test suite. For example, the individual VPN tests described above can all be part of a larger VPN test suite. In some cases, a test suite may require that certain specified types of applications be installed, over and above the basic applications installed on a device. For example, a VPN test suite can require that a particular type of VPN client be installed, while an anti-virus test suite can require that both an antivirus application and a VPN application be installed.

In addition, a test suite can be defined so that it can run for multiple versions of the applicable software. Thus, in an exemplary embodiment, a test suite can be defined so that at runtime, a check can be made to determine which version of the application is running on a device and the appropriate test script be loaded to test for that particular version. Each configuration of the test suite for a particular environment and set of applications and/or versions is known as a “test configuration.” A test suite can have more than one test configuration. For example, an antivirus test suite described above can have a first test configuration requiring first version of the antivirus software on first operating system and a second configuration requiring a second version of the antivirus software on second operating system, with both configurations requiring the same version of the VPN software. Alternatively, the antivirus test suite could require different VPN software applications in different test configurations while maintaining the same version of the antivirus application, language, and operating system across both configurations.

A test cycle can comprise a set of test suites having specific test configurations. For example, a test cycle can comprise one test suite defined for different test configurations of operating system, application version, and transport type. Alternatively, a test cycle can comprise multiple test suites or multiple test cases, all to be conducted using the same test configuration. In some cases, a test cycle may require that certain specified types of applications be installed, over and above the basic applications included in each test configuration, but not specify a version of that application. For example, a test cycle containing test suites can be used for validating an application such as Fiberlink's Extend360 interoperability software. In such a case, a test cycle could have an “Extend360” application type requirement. By specifying only that an application type such as “Extend360” without specifying a specific version of the application, the test cycle can thus be reused for any version of the application.

A test cycle also can be copied and edited as a new test cycle so that only the new information need be recreated, not the entire test. In addition, characteristics of the test cycle, such as whether the test cycle is active, i.e., should be included in a test queue, or whether the test cycle can be viewed or edited by others, can be defined or modified as appropriate by the user.

Test suites, test cases, and test cycles can be added to a test queue for selection and execution by a test device. For example, a test suite, and all of its active test cases, can be added to a test queue. In this case, if there are any application types that were defined for this test suite, the user will be forced to pick the specific application versions they wish to test, as well as the operating system and language they wish to test. A user also can select one or more individual test cases to be added to the queue. If the test suite that the selected test case belongs to has a defined application type, then the user will have to pick the application versions so that the environment prerequisites of the test are satisfied. For example, the user must select the operating system and language they wish to run, and then add the test case to the queue based on those parameters. Finally, a user can add a test cycle to the queue. If the test cycle has predefined any application type requirements, a specific version of each application type must be selected, then the test cycle (which represents one or more test configurations, i.e., one or more instances of suites added to the test cycle) is added to the queue. Any operating system or language selections would have already been made in the test cycle and are not needed at this step.

Once the user defines a test cycle, including the test configuration(s) for the test suite(s) comprising that test cycle, the user can then place the test cycle into a test queue for selection and execution by a test device. For an operator to separately select, load, and configure each possible combination of operating system, connection type, and application on each device would present a nearly insurmountable task. Thus, a key advantage of a test management system as described herein is that it can automatically load the necessary device configuration (e.g., operating system, applications, and connectivity transport) for a given test suite so that testing can be set up and executed without the need for any intervention by a user.

A test management system and client agent engine in accordance with one or more aspects described herein can perform one or more of the following tasks:
Maintain a library of test suites and test cases;
Maintain relationships between test suites and the applications that each suite requires for execution;
Allow a single test suite to run with multiple application and environment configurations;
Create reusable test cycles that can easily be configured to run as new versions of applications, devices, or other products are introduced;
Easily add new applications to the process and test existing tests against new versions of applications;
Offer a fully automated process that does not require a queue creator to manage or be aware of the physical test hardware or manually assign tests to individual machines;
Permit test devices to be re-imaged as necessary by automatically downloading and installing any necessary system configuration on test devices upon their selection of a test to run;
Permit a test to be automated across test device reboots;
Aggregate results from multiple test machines into a single repository for centralized real-time reporting;
Permit the addition or removal of test devices from the machine pool at any time without having to reallocate tests to specific test devices;
Retrieve information from external defect tracking systems to avoid running tests that have known failures or to provide defective information in test results;
Do not limit test case results to simply Pass or Fail but provide additional test result categories for handling scenarios other then explicit pass and fail; and
Include the ability to retry test cases, recover from failures in the machine environment, support configurable timeouts for each test attempt, gather diagnostic logging based on installed applications, gather crash data, and perform additional tasks as part of a robust error handling and recovery framework.

To accomplish these tasks, a test management system described herein can include one or more of the following characteristics:
Use of a Web portal to allow access from any PC for scheduling test runs and viewing results;
Test case organization by test suite;
Concurrent access to test suites and test results from multiple user accounts;
Security roles that allow for developer, QA, administrator, and other protected access levels;
Storage of scheduled tests in a shared queue for smart scheduling;
Database-driven shared system with test cases and results stored centrally in an open configuration that allows external reports to be generated and disseminated;
Integration with issue tracking tools such as Atlassian JIRA™ for real-time defect information;
Use by test devices of a pull versus push based way of allocating tests; this ensures that new test devices can be added at any time to meet changing demand;
Automated rebuild of test devices with all necessary software and configurations for test; this enables any device to be used for testing without the need for advance selection or preparation; and
Use of advanced execution queue creation rules:
   a. Inclusion of individual test cases and test suites while prompting for environment and dynamic application requirements on the fly
   b. Selection of test cycles from multiple users;
   c. Exclusion of test suites, for example, by available connectivity transport (dial, broadband, wireless, cellular, etc.) or hardware type (laptop computer, desktop computer, PDA, etc.);
   d. Exclusion of operating systems, languages, test suites, test groups, or individual application versions as needed;
   e. Exclusion of test cases with open defects using real-time issue tracker integration;
   f. Addition of further test components into the test environment; and
   g. Delay of start times for easy scheduling.

The ability to automatically reconfigure a test device to the requirements of a specific test suite is a key aspect of an automated test management system described herein. Such an automated rebuild of a test device can be accomplished by a device re-imaging and configuration tool such as the PC Build re-imaging tool offered by Fiberlink Communications Corporation. As noted above, although re-imaging aspects are described herein in the context of the PC Build re-imaging tool, it is expressly contemplated that other device re-imaging, configuration, or build tools can be used in an automated test management system as described herein. In most embodiments, the re-imaging tool will reconfigure the test device, for example, via commands from a command line interface; however, it is possible that a re-imaging tool can also be operated manually via a user interface, and both embodiments are within the scope of the present disclosure.

Irrespective of the particular tool used, aspects of a device re-imaging and configuration tool for use in a test management system described herein can include:
A single computer can be re-imaged into multiple operating systems;
Operating system re-images do not require use of external devices (e.g. DVD's, Network Shares, USB Keys, etc);
Re-imaged operating systems can expose all hardware, including wireless, mobile data, USB, and dial modems, to installed applications to permit full testing of connectivity software;
The re-image process can be either fully automated or manually driven; the re-image process can be menu driven for manual re-images and command line or API driven for automated re-images;
The re-image process can configure computer-specific settings such as a specific computer name and screen resolution;
The re-image process can be hardware independent and can support drivers for each hardware model;
The re-image process can be able to join a corporate domain;
The re-image process can install any valid combination of third party applications automatically; and
The re-image process can support independent updates to both the base operating systems and third party applications.

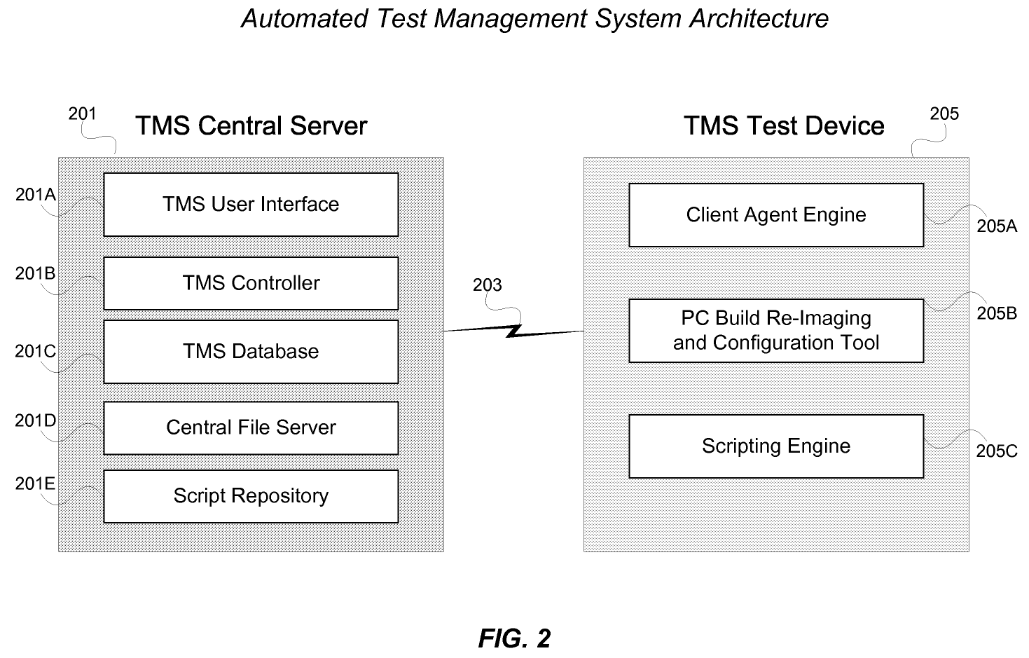

FIG. 2 shows an exemplary system architecture that can be used for an automated test management system and method having one or more of these aspects as described herein. It should be noted that the system architecture shown in FIG. 2 and described herein is merely exemplary, and that other system components and configurations can be used within the scope of the present disclosure.

In the exemplary system architecture shown in FIG. 2, an automated test management system can include a TMS Central Server 201 connected to a TMS Test Device 205 via a communications link 203. Communications link 203 can include a broadband connection such as a WiFi, Ethernet, or ISDN connection; a WAN or LAN connection; a dial-up link; or any other communications link between a server and a client device. TMS Central Server 201 shown in FIG. 2 can include TMS User Interface 201A, TMS Controller 201B, TMS Database 201C, Central File Server 201D and Script Repository 201E. The elements operate to enable a user to define and set up one or more tests for execution on TMS Test Device 205. To enable it to execute the tests set up on the TMS Central Server, TMS Test Device 205 can include Client Agent Engine 205A, PC Build Re-Imaging and Configuration Tool 205B, and Scripting Engine 205C. These elements of the TMS Central Server 201 and TMS Test Device 205 will be described in more detail below.

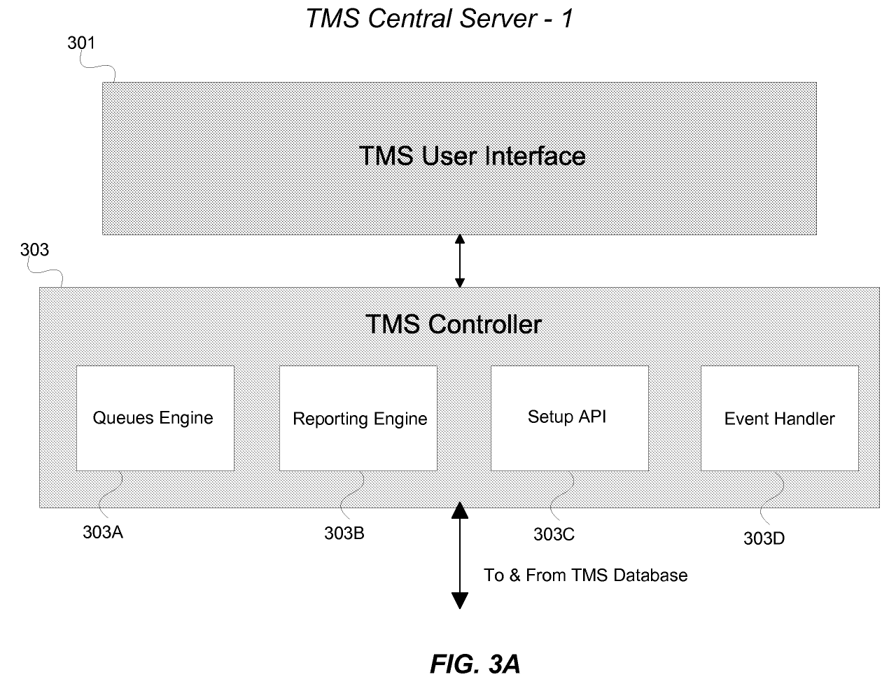

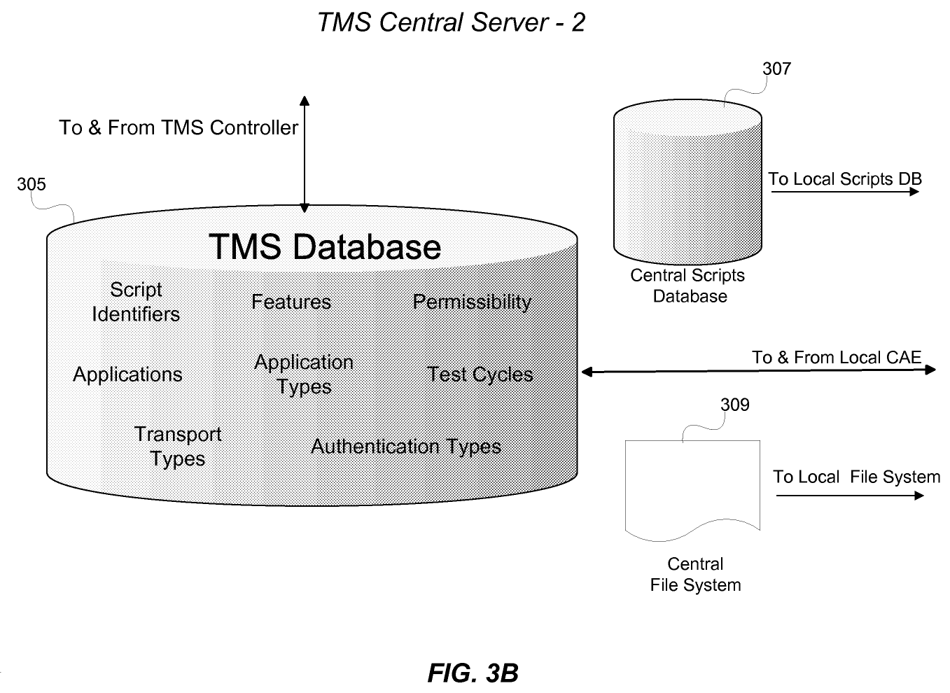

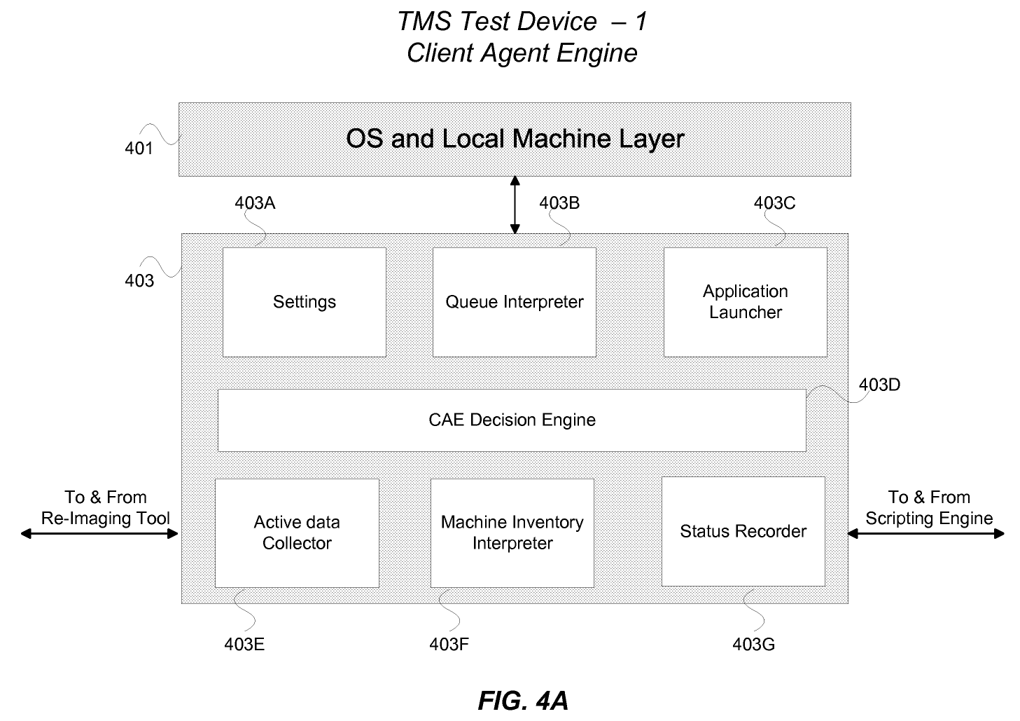

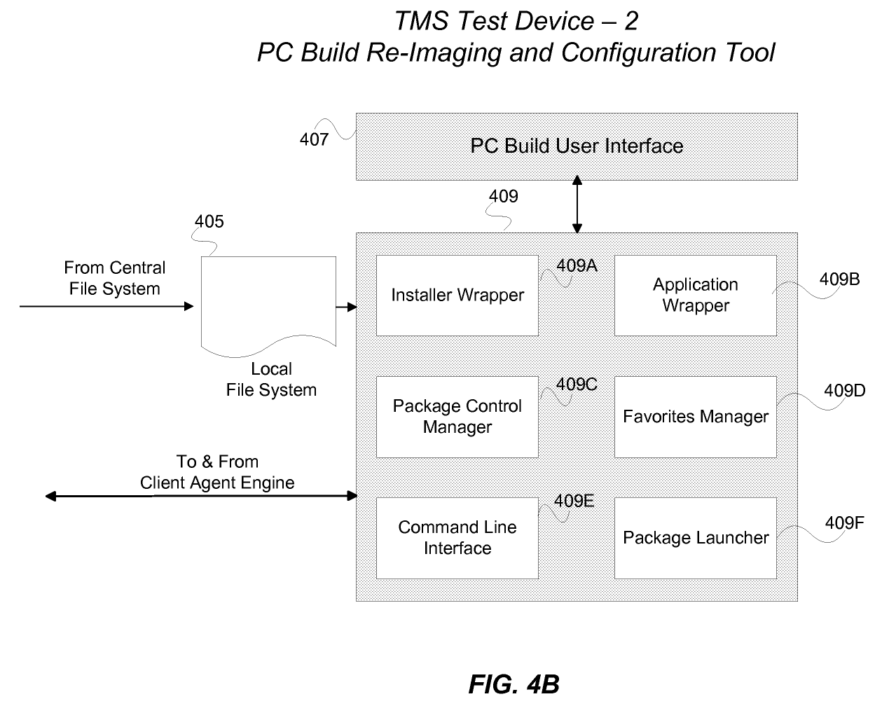

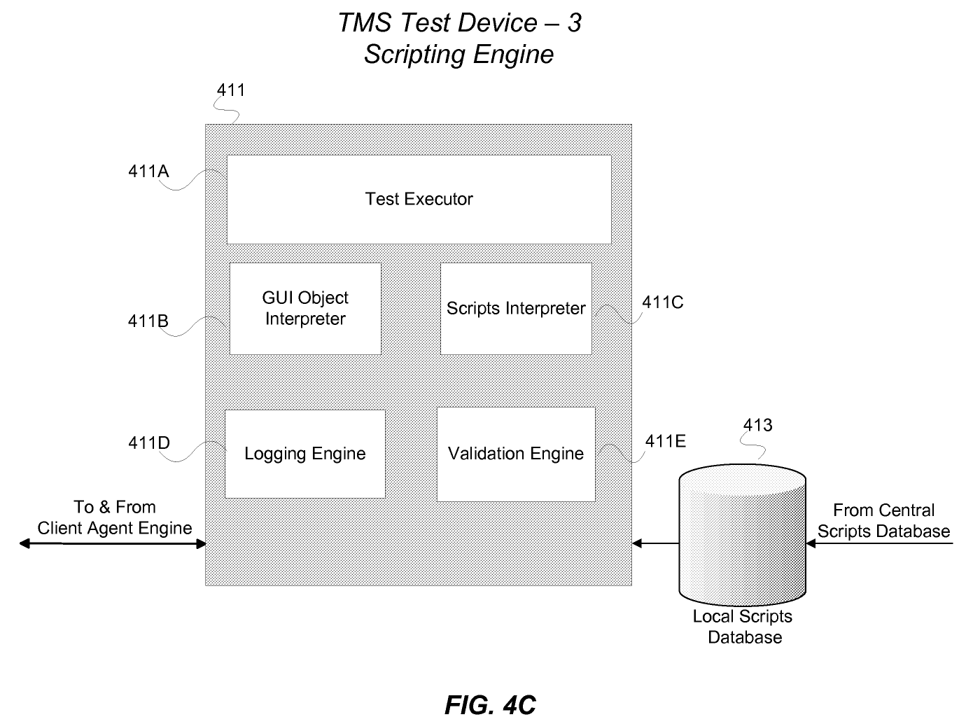

These and other aspects are described below with reference to the elements shown in FIGS. 3A-3B and FIGS. 4A-4C.

An exemplary system architecture for a TMS Central Server such as TMS Central Server 201 is shown in FIGS. 3A and 3B. As shown in FIGS. 3A and 3B, a TMS Central Server can include a TMS User Interface 301, TMS Controller 303, TMS Database 305, Central Scripts Database 307, and Central File System 309.

In accordance with aspects herein, TMS User Interface 301 can enable a user such as an enterprise's quality assurance manager to define tests to be run on the test devices by means of a simple, easy to use Web-based portal. Using TMS User Interface 301, a user can provide a login and password to access the Test Management System. By such a login process, TMS can validate that users are logged in for actions relating to the TMS. In some embodiments, all actions relating to the TMS, including viewing test results, require a login. In other embodiments, test results can be public to the enterprise, so that anyone in the company can view test results without logging in, for example, by viewing e-mailed links to results in a results database.

In addition, in accordance with well-known network management principles, an enterprise's system managers can identify users by their login credentials and can provide different levels of access to different persons depending on their role in the enterprise. In one example of use of such authorized access, administrative privileges such as executing code from the development branch and changing queue prioritization can be limited to authorized persons. As another example, a test cycle or a test queue can be “owned” by its creator but be managed either by its creator or by some other person such as the enterprise's quality assurance manager. These and many other aspects of access to the TMS can easily be managed by the login process.

After the user has logged on, using TMS User Interface 301, he or she can define parameters of tests to be performed on one or more test devices, including defining test cases, test suites, test configurations, test cycles, and/or test queues described above. In accordance with aspects and features of an automated test management system described herein, such test cases, test suites, and test cycles can all be saved for future use and edited as appropriate if new applications or new application versions are added.

As also shown in FIG. 3A, in addition to TMS User Interface 301, a TMS Central Server 201 can also include a TMS Controller 303 having a Queues Engine 303A, a Reporting Engine 303B, a Setup API 303C, and an Event Handler 303D. These elements are described below.

TMS Controller 303 can receive information of the defined test cases, test suites, test configurations, and test cycles from TMS User Interface 301 and as described below, the components thereof can set up, monitor, and manage an automated testing system having aspects and features described herein.

Via the TMS User Interface 301, Queues Engine 303A can perform queue-related tasks such as handling queue creation rules, monitoring queue status, and modifying queue prioritization. In accordance with aspects herein, a test queue can be created by including test cycles, test suites, and test cases. Upon inclusion of each item Queues Engine 303A can ensure that any required and still undefined test configuration selections, such as operating system, language, or specific application versions of required test suite or test cycle application types, are selected.

In addition, Queues Engine 303A also can create a set of all operating systems, languages, application types, applications, and transports needed for all test cycles, test suites, and test cases that have been included in the test queue. In accordance with other aspects, any of the above-listed parameters can be excluded from the queue. For example, a test cycle with 1000 test cases may be included in the test queue, but a specific version of a third party application having a known problem may be excluded from the queue so that it is not tested. Additionally, any tests with known failures or known incompletes may be excluded from the test queue so that they do not have to be repeated.

In accordance with other aspects, Queues Engine 303A also can globally select additional applications (other than those that will already be installed via test suite or test cycle inclusion) to be installed on each test machine executing items from the queue. This feature allows existing tests to run with additional applications installed for purposes of compatibility testing without the need to change existing configurations. For example, a queue with 1000 test cases may, without modifying the underlying test assets (test cases, test suites, test cycles), execute with the presence of an additional application to ensure the results remain unchanged.

Reporting Engine 303B can generate reports of the results of testing completed by the test device, including reports based on specific filters, and can display the results of testing on the TMS User Interface 301. In addition, in some embodiments, Reporting Engine 303B can send the results of testing in other ways, such as by e-mailing either the actual results or links to test results to appropriate personnel.

In some embodiments, standard queue results can be loaded as a test queue is executed and can be broken down by test group, test suite, and then test case. According to some aspects, a test case can show full test results if the test was successfully executed in its entirety, partial test results if the test was partially executed. Test results can also include each attempt to execute that test group if retries were used, and each individual attempt can show full logs from that attempt including text entries, validation criteria, errors, screenshots, file attachments, and other logging entries. In addition, status of all test cases in a test can be seen in real time. For example, a display of test cases on a user interface such as TMS User interface 301 can show a full list of test cases, which test case is being executed by which test device, and, for each test suite, can show the percentage of the tests in that test suite that have been completed and the results so far. Of course, the test information described above is merely exemplary, and there are many other types of test information that can be included and many other types of displays that can be used within the scope of the present disclosure.

Test logs can be filtered by operating system, language, loglevel, transport, result, or any other criteria. In addition, custom reports may be run based on test case, test suite, test cycle, installed applications, result, transports, and other TMS criteria that will span multiple queues. These or other custom reports can compare results over time, for example the result of individual validation criteria in a performance based test over a period of time.

Setup API 303C can allow automated processes, such as a nightly build, to automatically add application information to the TMS database. Setup API 303C also can initiate test queues, such as unattended smoke tests, on its own.

Event Handler 303D can respond to and handle events raised by the system such as new queue notifications to notify personnel, for example, by e-mail message, that new queues have been created; or queue completion notifications to notify personnel that a queue has been completed and/or to send queue results. Event Handler 303D also can handle maintenance of the testing system such as periodic scheduled database maintenance, including cleanup of queues and other assets flagged for deletion as well as removal of log and file attachments meeting specified criteria.

As shown in FIG. 3B, the TMS Central Server can also include a TMS Database 305 that communicates with TMS Controller 303. As shown in FIG. 3B, TMS Database 305 can include, among other data items, data relating to script identifiers, features, permissibility, applications, application types, test cycles, transport types, and authentication types. Any or all of these data items can be defined or edited, for example, by a user using TMS User Interface 301.

In addition to TMS Database 305, TMS Central Server 201 can also include a Central Scripts Database 307 which can communicate with a local scripts database on the test device, such as Local Scripts Database 413 described below. Development of automation scripts for execution of test cases can be performed on a central server such as TMS Central Server 201 and the scripts stored in Central Scripts Database 307. During setup of a test device for testing as described in more detail below, Local Scripts Database 413 can copy the specific version of the test script for the test suite and test configuration to be executed on the test device from the Central Scripts Database 307; once the script is copied, the test device uses that copy as stored in Local Scripts Database 413 to execute the tests on the device.

Also as shown in FIG. 3B, TMS Central Server 201 can also include a Central File System 309 which can communicate with a local file system on the test device, such as Local File System 405. In an exemplary embodiment, Central File System 309 and TMS Central Server 201 are specific to a particular site, and thus there is no cross-site network traffic needed to effect communication between the central sever and the central file system. The use of a site-specific central file system communicating with a site-specific central server servers combined with the use of a local file system on the test device can thus advantageously minimize the amount of network traffic involved in setting up and executing test in the system.

Central File System 309 can communicate with Local File System 405 as part of the re-imaging and reconfiguration of a test device in accordance with aspects described herein. As described in more detail herein, the PC Build tool on the local test device can automatically re-image and configure a test device by loading all operating system, applications, and configurations needed for a particular test suite onto the test device. The PC Build tool thus allows any device to be used for any test without the need to preconfigure the device and without any limitation on the test that can be run based on the device's current configuration so long as the test's hardware requirements are met. In order to accomplish this, the test management system can use Central File System 309, which can include the base operating system images for OS installation as well as a library of application packages used for automated install of programs onto a test machine. In this way, all up-to-date application packages and versions can be centrally stored. When a reconfiguration of the local device is performed or when the PC Build tool performs background updates, for example, to synchronize its local file system, the Local File System 405 can copy any applicable files from Central File System 309. Thus, TMS Central Server 201 can use Central File System 309 as a corporate source code repository to ensure proper controls when making changes to application installation packages.

FIGS. 4A-4C depict aspects of a test device in a test management system according to one or more aspects and features described herein.

As shown in FIG. 4A, a local test device can include an operating system (OS) and Local Machine Layer 401 and a Client Agent Engine 403 operatively connected thereto.

OS and Machine Layer 401 represents the physical hardware the test applications run on, as well as the installed operating system and all applications under test. Every component within the testing process interacts with the operating system and machine hardware at least to some extent. It should be noted that an automated test management system and method in accordance with aspects and features described herein is not limited to any specific operating system or hardware configuration, but can be adapted as appropriate to work with any operating system and/or any configuration of hardware or devices.

Client Agent Engine (CAE) 403 is the ‘brain’ of a test device in an automated test management system described herein. It is responsible for interacting with the host operating system, launching test applications, communicating with the server-based TMS, and aggregating results. It also communicates with the PC Build system configuration application shown in FIG. 4B and the Scripting Engine shown in FIG. 4C to provide automated setup and execution of tests on the test device.

In an exemplary embodiment, CAE 403 is a fully automated client that in the ordinary course of use has no reliance on user input. In such cases, the only user interface comprises a status screen that is displayed between test attempts, while the CAE is processing test results, or while the CAE is polling the queue. It is possible, however, that other embodiments of CAE 403 may have more user interfaces that permit some user interaction, and such embodiments are contemplated to be within the scope of the disclosure herein.

As shown in FIG. 4A, CAE 403 can include a local Settings file 403A, a Queue Intepreter 403B, an Application Launcher 403C, CAE Decision Engine 403D, Active Data Collector 403E, Machine Inventory Interpreter 403F, and Status Recorder 403G.

In accordance with aspects herein, CAE 403 can select one or more settings from local Settings file 403A to change the settings for execution of a test suite on the test device. These local settings can be in the form of overrides of default settings for the test suite, and can include settings such as setting a startup delay, i.e., the delay before the CAE initiates the queue interpreter; setting a retry delay, i.e., the delay between test attempts; and launching scripting engine diagnostics to enable more detailed reports and logs to be generated which can be useful for debugging purposes.

CAE 403 can retrieve its work units, i.e., test suites to be executed on the test device, from Queue Interpreter 403B. Queue Interpreter 403B can communicate with TMS Database 305 and can check out work units (e.g., test suites in the test queue) for CAE 403 to process on the test device.

In addition, in accordance with aspects described herein, although work units that can be executed on a test device are not limited by the device's current configuration, Queue Interpreter 403B can use logic to minimize total test device re-images by intelligently selecting work units based on the abilities of the test device. For example, a test configuration can include an instance of a test suite with a specific operating system, language, and application configuration. Therefore goals of Queue Interpreter 403B can include running an entire test suite on the test device with a given configuration. Executing a test suite with one configuration will require no more then a maximum of one re-image (zero, if the configuration is already met) provided the test device supports all required hardware requirements. Thus, when the Queue Interpreter 403B finds a test configuration that CAE 403 can execute, either with or without needing a re-image of the test device, Queue Interpreter 403B can check out all test cases in the queue having that same configuration and hardware requirements. By doing this, Queue Interpreter 403B can prevent another test device from executing them or from, re-imaging itself only to find that the tests for that configuration have been completed and that any new tests will require another re-image of the test device.

In an exemplary embodiment, Queue Interpreter 403B can use the following four checks to query the TMS Database 305 queue to obtain work units to execute on the test:
1. The first check is for test configurations that can be run in their entirety using the test device's current configuration (i.e., OS, language, installed applications, and currently available hardware, etc.). This ensures that a full test suite can be executed on the test device without the need to re-image the device for additional tests or the need to re-image another test device so that the second device can complete a part of the test suite not executable on the first test device.
2. The second check, used when the first check yields no results, is for test configurations that can be run, in any part, using the test device's current OS, language, installed applications, and available hardware. This is the case when only limited hardware is available, and makes some use of the test device's current configuration even if the entire test configuration cannot be completed on the test device. For example, although some test devices may support multiple connection transport types, such as WiFi and broadband, some test devices (or test devices running as virtual machines) may offer more limited transport support, such as only broadband. In this case, part of the test suite can be completed without a re-image of the test device, but at some point another test device (having more hardware options available) will need to execute the test cases in the test suite that are not supported by the original test device's configuration.
3. If the first two checks yield no results, the current test device configuration is unable to execute any tests without a re-image. This third check will find tests that require a re-image but can be executed in their entirety using the re-imaged configuration with the test device's available hardware. Of those, it sorts them first by priority, then by the largest number of applications to be installed, if any. Queue Interpreter 403B can then select the test configuration with the largest number of applications to increase the probability that the selected test configuration can be reused for additional tests after the initial tests have executed.
4. The fourth check is used when the third check yields no results. Like the third check a re-image of the test device will be required. This check is the same as the third check, but can also accept tests that can be partially run on the test device with the device's available hardware. Since this is only a partial run, however, another test device eventually will need to run the remaining tests in the test suite. However, partial execution of a test configuration, i.e., execution of only some of the test cases in a test suite on one device, with a re-image of a second device required to complete the test, is preferable to not running any tests at all on the device.
   If all results have finished and Queue Interpreter 403B is unable to find any work units to execute, it can idle for a period of time, e.g., until a predefined retry interval has elapsed, at which point it can re-query TMS Database 305 for new work.

Application Launcher 403C can manage the CAE's relationship with other core framework applications in addition to launching, and monitoring, generic applications and utilities. As described herein, during the testing process, it may be necessary to reconfigure a test device, and thus, in accordance with aspects herein, interaction with PC Build tool 205B on the test device can be an important function of Application Launcher 403B. In accordance with aspects herein, PC Build tool 205B can store previous build information in a “favorites” file in its data folder. In preparing for a re-image of the test device, CAE 403 can generate a new temporary PC Build-compatible favorites file using the new operating system, language, and list of required applications. In an automatic re-imaging and reconfiguration of the test device using the PC Build command line interface, the PC Build re-imaging tool is launched with the temporary favorites file provided as an argument. PC Build then can take over and re-image the test device to provide the proper configuration for the next test.

Interaction with a scripting engine on the test device, such as Scripting Engine 411 shown in FIG. 4C, is another important function of Application Launcher 403C. As described in more detail below, Scripting Engine 411 can accept input from an input file and via command line parameters. Application Launcher 403C can generate the input file and can write parameters such as test case name, output file path, and data log level for use by Scripting Engine 411. Once the input file is generated, Application Launcher 403C can initiate Scripting Engine 411 using command line arguments and can pass the expected arguments to start the driver script.

In some configurations, there also can be one or more generic applications, typically in the routine process of log collection and machine maintenance, which can be managed by Application Launcher 403C. Some common tasks that Application Launcher 403C can perform in managing these generic applications can include managing compression utilities for log file aggregation, launching proprietary tools for gathering logs, running tools for managing the test device environment, etc. Knowledge of and management of such activities are well within the skill of one in the art and so are not described in detail here.

A key component of CAE 403 is CAE Decision Engine 403D. CAE Decision Engine 403D is a constantly running process that is responsible for launching all other CAE components. CAE Decision Engine 403D also can monitor the progress of test case execution on the device and make decisions for additional actions based on the progress of the test case and its execution. In accordance with aspects described herein, CAE Decision Engine 403D can perform tasks such as invoking Queue Interpreter 403B to query for work units, initializing Scripting Engine 205C using Application Launcher 403C for running a test, monitoring the scripting engine for completion within a test case's predefined timeout; initiating reboots and re-images if required for each test case; initiating retries for incomplete and failed test cases if test case retries are enabled; polling the active data collector for the “health” of the machine including low memory and crash scenarios, then recovering as needed; and polling the active data collector based on results of the status recorder to initialize logging plug-ins when needed. These and other functions of CAE Decision Engine 403D will be described in more detail below.

Other aspects of CAE 403 relate to logging and management of data generated during testing. In accordance with aspects of an automated test management system described herein, extensive log files can be generated by Scripting Engine 411, and these files can be parsed and stored in TMS Database 305. These logging and management functions can be performed by one or more of Active Data Collector 403E, Machine Inventory Interpreter 403F, and Status Recorder 403G in CAE 403.

For example, following completion of each test case, a log file such as an XML log file can be parsed and all log, error, and validation criteria statements be individually processed and entered into TMS Database 305. TMS Database 305 can use separate tables to store each data type, and the data processing aspects of CAE 403 can ensure that items are processed in the correct order and assigned a global sequence identifier to preserve their order across tables. Active Data Collector 403E can also include one or more paths for file attachments in the XML log file. Screenshots and other logs can be compressed by Active Data Collector 403E and uploaded to a file share system and entries with the file properties can be created for each file in TMS Database 305.

According to other aspects, information about the test device and results of the test case is collected and logged to local log files during test case execution. For example, system statistics, including memory utilization and running processes, can be logged and abnormal results, such as system crashes, can be detected. Active Data Collector 403E can attach these log files to the TMS test case results in TMS Database 305 and can upload any crash dump files, if such dump files are detected. This happens independently of the scripting runtime, eliminating the need to explicitly code for general error scenarios within test scripts.

In addition, Active Data Collector 403E can support plug-ins for additional logging. Based on the test case return value each plug-in can initiate application-specific logging. The plug-in can generate a log if the application test generates any result expected by the plug-in. For example, a plug-in can be used to log unsuccessful test results. If one of the tested applications generates diagnostic logs, additional logs from the plug-in can be used for additional debugging in the event of a “Fail” or “Crash” result. The plug-in generated logs can be attached to the test results.

Machine Inventory Interpreter 403F is responsible for detecting the capabilities of each test device and making this information available to PC Build tool 205, for example, via Application Launcher 403C, and to TMS Controller 303. For example, in order to determine if a re-image is required, Queue Interpreter 403B should know information regarding the test device such as the device's hardware, current operating system, language, list of installed applications, and available transports. In accordance with aspects herein, this information can be obtained by Machine Inventory Interpreter 403F and sent to other components, such as Queue Interpreter 403B, for their use. The information can be periodically uploaded to TMS Controller 303 and can be displayed on TMS User Interface 301, for example, on a “Machine Status” display.

In accordance with aspects herein, CAE 403 also can include a Status Recorder 403G. Status Recorder 403H is responsible for interpreting the final result of a test case received from Scripting Engine 411 and logging the result of that test case into a TMS Database such as TMS Database 305.

Aspects and features of a test device re-imaging tool that can be used in an automated test management system described herein are shown in FIG. 4B. Thus, as seen in FIG. 4B, PC Build Test Device Re-Imaging And Configuration Tool 409 can include a PC Build User Interface 407, an Installer Wrapper 409A, an Application Wrapper 409B, a Package Control Manager 409C, a Favorites Manager 409D, a Command Line Interface 409E, and a Package Launcher 409F.

As described above, in most embodiments, the re-imaging and reconfiguration process according to aspects and features herein will be accomplished automatically, without any user input. In those embodiments, a user interface on the test device such as PC Build User Interface 407 will not be used to prepare a device for testing, but optionally can provide a display so that a reconfiguration or test progress can be viewed or monitored by a user. However, in some embodiments, PC Build User Interface 407 can also be used for some re-imaging functions, for example, if a device re-image is manually started or when a post-configuration functionality of the package launcher is used. In such embodiments, PC Build User Interface 407 can permit a user to manually initiate a re-image of the device, for example, by selecting a new operating system and new applications to be installed or by selecting applications to be installed into the current operating system.

In accordance with aspects and features described herein, in most embodiments, a re-imaging application such as PC Build can effect the automatic configuration of a test device with a user selected operating system and list of applications through a fully automated, unattended process. As noted above, although in some embodiments it may be possible that one or more of these selections can be made by a user via PC Build User Interface 407, in most embodiments, these selections can be made by PC Build without any user intervention, for example, via a command line interface. Thus, in an exemplary embodiment, PC Build can make one or more of the following selections to re-image and configure a test device:
Operating System: The operating system and/or OS/Service pack combination. Supported operating systems can exist as baseline images in the local PC Build file system.
Language: The operating system language. Different operating systems support different languages. The OS/Language combinations can be defined in the PC Build configuration file, with only valid configurations being available for selection.
Package Group: PC Build can support sorting packages (i.e., third-party application installers), by package group. This can allow different enterprise departments to have only packages relevant to their needs available for selection by the build process. In an exemplary embodiment, PC Build can automatically detect the test device's group membership and select one or more default packages for that group.
Packages: PC Build can select one or more application packages for installation. PC Build can obtain package information by issuing a query to an appropriate component such as Package Control Manager 409B. Some packages may be automatically selected as defaults, although this may be overridden, for example, by a user making manual selections via User Interface 407. Some packages may also automatically select other packages that have established package dependencies.
Default Security Applications: By default, PC Build will install an antivirus and firewall application, though it is possible to override this behavior via selections in Settings file 403A.
Automatic Login: PC Build can configure the host operating system to automatically login as a particular preexisting test account. This is used for both automation testing as well as a convenience during manual testing.
Domain Membership: PC Build can optionally join a domain for operating systems that support domain membership.

While PC Build can be used to configure a test device from scratch, including installation of a new operating system, it is can also be used to install applications into an existing configuration. PC Build permits the installation of applications and application packages onto a test device without having to first remove and re-install the OS. This package launcher mode displays all packages supported by the current OS and Language. Any applications that are necessary for a particular test configuration or that are otherwise selected (e.g., though a manual selection) can be automatically installed.

In addition to re-imaging and package installation, PC Build can support administrative options for image customization and automated changes to the operating system.

For example, a PC Build configuration file can predetermine a list of “Default” operating systems that are automatically synchronized using the background update process. These defaults address the majority of use cases for commonly used configurations, though some departments may require additional customization. In addition, modified OS baseline images can be created. In some embodiments, PC Build also can support image filtering so that additional images can be permitted or unwanted images can be excluded.

In some embodiments, PC Build also can permit certain OS settings to be modified following the completion of a re-image. For example, some operating systems support changing languages in an existing installation, and in some embodiments, this selection can be provided in a user-selectable menu, for example, in a menu in the Settings 403A interface or in PC Build User Interface 407.

Also as shown in FIG. 4B, a local copy 405 of PC Build file system can be maintained on the test device. By having a local copy of the PC Build file system, network congestion during the test device configuration process can be eliminated since communication with the network is not necessary during the process. A local file copy also allows for offline re-imaging. Local PC Build File System 405 can include both a copy of operating system baseline images used for OS restoration, and a copy of application packages used for automated installation of applications. A background update process can ensure that the local copy is kept up to date with any server changes. The update process can connect to site-specific servers to eliminate WAN traffic.

As noted above and as shown in FIG. 4B, PC Build test device configuration tool 409 also can include an Installer Wrapper 409A. In an automated testing management system in accordance with one or more aspects described herein, Installer Wrapper 409A can automate the process of installing and configuring an operating system on a test device. In accordance with aspects herein, the entire OS installation can be performed locally, independent of a central image server or a static machine-specific image of a test device. The methods used to automate the OS install will vary based on the type of OS, but the OS installation process according to aspects herein can fully automate OS installation, ensuring that a single OS image supports all hardware types.

PC Build test device configuration tool 409 also can include an Application Wrapper 409B. Application Wrapper 409B can encapsulate a third-party application installer, allowing the installation process to silently install without user interaction in an unattended environment. Application installers for third-party applications can exist within a file system, sorted by folder, with each folder containing a combination of installer and application wrapper in a single package. Although there are many possible configurations of an application package, in an exemplary embodiment according to aspects and features described herein, an application package can contain the following components:

First, an application package can include a properties file for the package. Information regarding the package that can be included in the properties file can include package description; application name; application type (e.g., VPN, Firewall, Tool, etc.); the order in which the package is to be installed relative to other packages; whether the package is a default package that is automatically selected and installed; whether the package is active or inactive; and whether a reboot is required after installation. Of course, these listed properties are merely exemplary, and other properties or more detailed information regarding these or other properties can also be included in the properties file.

Second, an application package can include installation files for the application. In accordance with installation procedures known in the art, these installation files can vary depending on the application installed.

Third, the application package can optionally include initialization files that automate the application installation. Thus, in some embodiments, the file to launch can be specified in the properties file and may be the actual application installer, such as “setup.exe” or “install.exe,” with a command line argument to specify a silent installation. However, other times the initialization files are custom files such as some installation script or a GUI installation automation script.

Also as seen in FIG. 4B, PC Build tool 409 can also include a Package Control Manager 409C. This component of the PC Build tool can scan the Local PC Build File System 405 for packages available for installation, process the application wrapper for each such package, and send the package information to Package Launcher 409F so that the package can be installed. Package Control Manager 409C can also send information regarding the package to PC Build User Interface 407 so that the package can be installed if the device is to be manually re-imaged by a user through the User Interface.

Favorites Manager 409D can be used to save the intended configuration of the test device as a “favorite.” Favorites Manager 409C can be used both during a fully automated re-imaging process and during a manual re-imaging performed by a user using PC Build User Interface 407. For example, Favorites Manager 409D can write all information for a particular build to a “favorites” file having a file extension such as “.pcbuild” located in a folder such as the PC Build directory's “Favorites” folder. Each favorites file can include any or all of the information required for a re-image, including operating system, language, and required third party applications. Favorites Manager 409D also can track the “Last Build” configuration, i.e., the most recently re-imaged settings, which can be used by PC Build User Interface 407 to load last-used settings or by a fully automatic re-image process as part of a task list for what to install.

PC Build re-imaging tool 409 can also include a Command Line Interface 409E which can be used by the Client Agent Engine to initiate a re-image process programmatically in accordance with aspects described above. It is contemplated that such a programmatic re-image will be used in most embodiments of an automated test management system described herein.

Package Launcher 409F can initiate the installation of application packages, both default application packages and application packages for selected third-party applications.

Package Launcher 409F can be launched in one of two ways, either automatically via Command Line Interface 409E or by manually via PC Build User Interface 407.

If Package Launcher 409F is launched via Command Line Interface 409E, it is launched as part of a complete re-image process. The call to Package Launcher 409F can be made by the operating system after the OS configuration has completed to begin the package installation process. In this embodiment, Favorites Manager 409D can load a device configuration, for example, by loading the LastBuild.pcbuild configuration that was saved prior to the start of the re-image process and scan the local file system and load all default and selected packages. Package Launcher 409F can then iterate through each package and initiate the package installation command. In an exemplary embodiment, packages are installed in the sequence specified in their application wrapper and then alphabetically; however, it is contemplated that in other embodiments, other installation schemes can be established and that packages can be installed according to those other scheme as appropriate. Package Launcher 409F can wait for the installer to complete and can reboot between packages or between installation commands, as determined by Application Wrapper 409B. When all packages have been installed Package Launcher 409F can return control to the host OS and await further instructions.

As noted above, Package Launcher 409F also can be started via PC Build User Interface 407, for example, if a user wishes to install one or more packages into an existing OS configuration without requiring a re-image of the device. In this case, Favorites Manager 409D does not retrieve last build information. Instead, Package Control Manager 409C can be loaded (as part of the User Interface) and can include a list of packages available for loading on the device. Package Launcher 409F can process each item selected from the list, installing the packages, in the sequence specified in their application wrapper and then alphabetically (though as noted above, other sequences for installation also can be established).

FIG. 4C depicts elements of a Scripting Engine that can be used in an automated test management system according to aspects and features described herein. Scripting Engine 411 can include functionality that receives, processes, and executes test scripts on the test device. As shown in FIG. 4C, Scripting Engine 411 can include Test Executor 411A, Logging Engine 411B, Validation Engine 411C, GUI Object interpreter 411D, and Scripts Interpreter 411E.

Also as shown in FIG. 4C, Scripting Engine 411 can also be connected to a Local Scripts Database 413. Local Scripts Database 413 can communicate with the Central Scripts Database 307 in the TMS Central Server and can import test scripts from Central Scripts Database 307 for use on the test device. Use of such locally stored scripts can help ensure that any temporary loss of network connectivity during a test case will not result in testing or other automation errors.

As noted above, Scripting Engine 411 in an automated test management system described herein can include a Test Executor 411A which can execute the test scripts on the device. In an exemplary embodiment, Test Executor 411 can be initialized via a command line interface to automate the initialization and execution of testing of the test device. Once Test Executor 411A has been initialized, it can read an input file such as a file generated by Application Launcher 403C and determine the test case to be run. Based on the test case, Test Executor 411A can then load the appropriate test script and set the initialization point for the script at the specified test case. Test Executor 411A also can perform initialization of global modules and complete other script level prerequisites. Once the global modules have been initialized, scripts have been loaded, and other prerequisites have been completed, the test case script can begin on the device so that the test can be run.

In an exemplary embodiment of execution of a test case, each statement can be passed ether to GUI Object Interpreter 411B or to Scripts Interpreter 411C, based on predefined parameters such as command type, for execution. For example, GUI Object Interpreter 411B can receive commands from Test Executor 411A whenever a GUI command is encountered and can automate GUI interaction with test applications, such as clicking on buttons or capturing text from a message box. Scripts Interpreter 411C can execute all non-GUI directives, such as file manipulation and standard programming logic.

Logging Engine 411D can maintain log records of the execution and results of a test case, and can perform one or more of the following tasks:
Open/Close text & XML log files;
Write logs, errors, and validation criteria to the log files;
Capture screenshots during validation criteria evaluation and in each test case, as needed;
Create copies of files that will need to be uploaded to TMS;
Compress files to save space;
Write current test status to temporary files to handle automation across reboots; and
Read from temporary files after reboots to resume progress.
   The log files created by Logging Engine 411D can then be passed to the TMS Database 305 for review and analysis by enterprise personnel.

Validation Engine 411E is a key component of Scripting Engine 411. It is responsible for receiving and evaluating the data regarding the results of tests being run on the device.

For example, each test case can predefine validation criteria and testable conditions to be evaluated during the test case at the start of the test, before any steps are executed. Many benefits can be achieved by defining all test objectives before test steps are run and evaluating these objectives using a special method instead of only basic logging. An automated test script that does not pre-define all validation criteria relies solely on the developer to remember to code for each check in each possible code path. By declaring the full set of objectives prior to the start of the test case execution, Validation Engine 411E can ensure that no test can pass unless all defined criteria have been evaluated. In addition, a clearly defined list of test objectives serves as an outline for script coding. The list of criteria can be created based off a documented manual test case, a requirements document, or any other process that clearly identifies test objectives.

As a test case is executed, the validation criteria can be evaluated. Based on the results of individual steps, Validation Engine 411E can determine if the test should continue or abort. At the conclusion of all tests, Validation Engine 411E can calculate the final test case result and can assign a value such as Passed, Passed with Warnings, Incomplete, Failed, and Unknown.

A test script (manual or automated) that does not define all pass/fail criteria will typically assume that a test case, without generating an explicit error, is the equivalent of a pass. While manual testing is able to rely on a skilled tester's instincts and experience, an automated test is far more precise in how a pass can be determined and requires a safer approach. The default process in commercial automation tools assumes that a test case which has not explicitly logged a failure is a pass. This process fails to eliminate false positives, tests that have failed but report a pass. With this configuration if a check for a test objective that would have generated a failure is omitted the test has passed. By pre-defining all criteria it is impossible to generate a false positive if a check fails to execute.

Using pre-defined validation criteria, as opposed to checks spread throughout a test case, also can simplify the validation criteria maintenance process. If a validation criteria's expected result must be changed, it can be changed from a single location. Using named, centralized, human-readable criteria—as opposed to code—removes the requirement for a developer to have to make code changes to change the expected result of a test case. Validation Engine 411E can invalidate the result of a test both if any new criteria are added and not evaluated, as well as if an existing criteria's evaluation has been removed. This further reduces the risk of human error.

In accordance with aspects described herein, validation criteria for a configuration test can be defined with one or more of the following properties:
Name: The name of the criteria. The name is human readable text that, when viewed in a report, clearly explains the text objective
Criteria Type: The type of criteria to be evaluated. The criteria is evaluated differently based upon the criteria type. Possible criteria types can include:
   Boolean: True/False check
   Numeric: Numeric range
   Text: Verify specific text comparison is met
   RegEx Test: Verify that a value matches an expected pattern
   RegEx Match: Verify that the result of a regular expression match equals a value.

Characteristics of other validation criteria can include:
High/Low Limit: The expected result when the criteria is evaluated. Some types of criteria, such as Boolean types, only use a single value (i.e. “True”) but some criteria types use ranges, such as the numeric type (e.g., between 1-5).
Continue On Failure: Indicate whether, in the event this criteria fails, the test case should continue. This can be used when the criteria must pass and no useful results would be obtained from evaluating subsequent criteria. For example, if an application fails to launch it would not be possible to evaluate that the application's window text was correct. When critical criteria contribute to the flow of a test case by aborting on a failed step it reduces the need for a script programmer to code for the additional branches, resulting from checking criteria return values.
Objective: This characteristic can indicate whether the criteria is a primary or secondary test objective. If any primary objective fails the test will have failed. Most criteria will typically be primary objectives. Non-objective criteria are used to alert quality assurance to a potential problem when the check is not a primary objective of the test case. For example, consider a test case to verify that a window opens when a button is clicked. One validation criteria could ensure that the window opened when the button was clicked. Another validation criteria may check that the window opened within five seconds. If the window took six seconds to open that would result in a failure of one criteria. As the objective of the test was to ensure the window opened, and not how fast the window opened, the second criteria may not be an objective and would not result in a test case failure. The performance problem would be logged as a failure of the specific criteria, but not a failure of the entire test case.
   Of course, many more criteria types are possible and variations on these types can be made and all such different criteria types and variations are within the scope of the present disclosure.

Validation Engine 411E can evaluate each validation criteria individually as the script progresses. In one exemplary embodiment, Validation Engine 411E can accept a run-time value for each criteria to represent the actual result of the test as to that criteria. Validation Engine 411E can then compare this actual result to the expected result (or result range), and can determine a pass or fail status of the test as to that critera. If the criteria has failed, and the test is not allowed to continue if that criteria fails, the script will abort.

When the script has finished, either through an error or successful completion of all steps, Validation Engine 411E can evaluate all validation criteria collectively to determine the overall test case result. Some possible test case results include:
Pass: All validation criteria ran and returned pass results.
Passed with Warnings: All validation criteria ran. At least one criteria failed, however none of the failed criteria were primary test objectives. As secondary objectives, these failed criteria can generate a warning instead of a failure.
Failed: At least one primary validation criteria has failed. It is not necessary for all criteria to have finished since even one failed objective criteria is sufficient to have failed the test case.
Incomplete: Not all validation criteria have completed and none of the completed criteria have failed.
Unknown: An unexpected error has occurred before validation criteria could be added. For example, test case prerequisites may have failed or a required application may not be installed. When no validation criteria have been added the result is unknown and reflects some configuration error that must be investigated. Use of the unknown status separates real failures, tests that successfully executed and failed, from tests that could not be run.

The results of the test based on these or other validation criteria can then be passed to TMS Database 307 for review and evaluation of the operation of the test device based on the test case, test suite, and test configuration used.

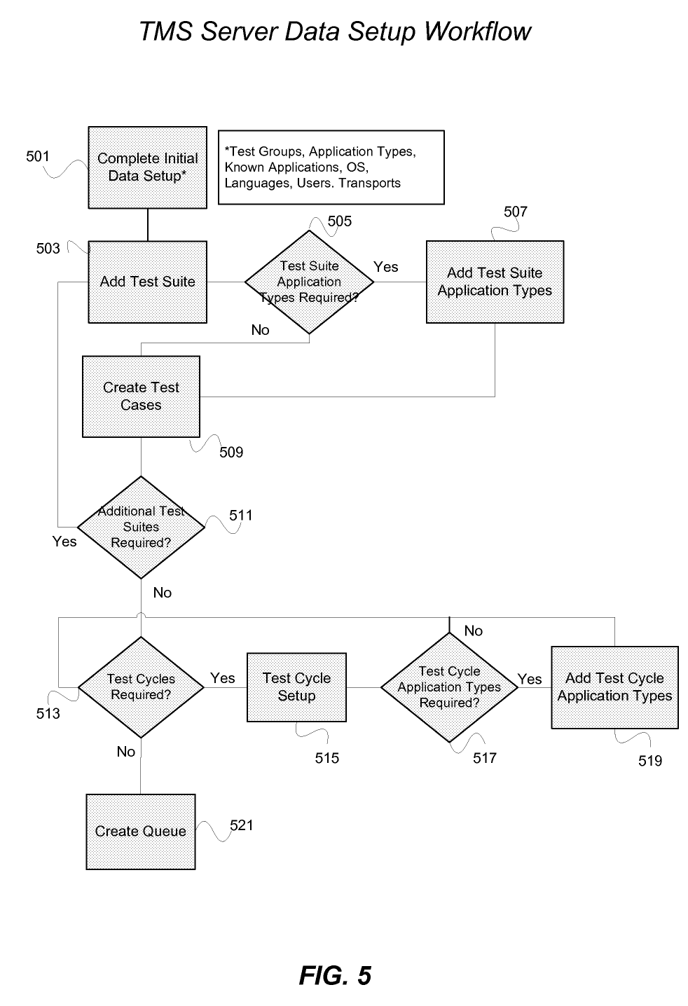

FIGS. 5 to 11 depict exemplary logic workflows for a testing process in a Test Management System according to aspects and features described herein. These steps can be performed by one or more software modules residing in a central server, one or more test device, or both.

FIG. 5 depicts an exemplary workflow for initial test data setup, in preparation for queue creation, by a TMS server such as TMS Central Server 201. After the initial setup has been completed, only new items would need to be created for future queues. It should be noted that the steps and order of steps depicted in FIG. 5 is merely exemplary, and that other implementations may have other steps or steps performed in another order, and remain within the scope of the present disclosure.

As seen in FIG. 5, at step 501, the initial data setup can be completed on the server, for example, TMS Server 201 described above. This data setup includes addition of new application types, applications, operating systems, languages, transports, users, and any other items that may have changed since the last time setup was completed. New items can be continuously added and this represents both initial setup and maintenance of adding new items.

Once the initial data setup is complete, test assets may be created, for example by a user using TMS User Interface 301.

To start the creation of test data setup, at step 503, the server, in conjunction with user selections made via the user interface, can begin setup of a test suite. In an exemplary embodiment described herein, testing in a test management system revolves around the concept of a test suite, so at least one test suite must exist. In addition, new test suites can be created for new tests to be performed on the test device. When a test suite is created, all its properties such as “test group,” “active,” “reboot/re-image required,” etc., are set. In addition, when a test suite is created, there can be an option to require an application type, and at step 505, the user can indicate whether the test suite requires a particular application type to be installed on the test device in order for that test suite to be executed. If the answer at step 505 is no, processing proceeds directly to step 509. If the answer at step 505 is yes, then at step 507, the appropriate application types can be selected by the user and added to the test suite requirements. Once the desired application types have been selected, processing proceeds to step 509. In accordance with aspects described herein, each test suite must specify the tests that it runs, in the form of test cases. Thus, at step 509, the user can add all test cases that will be used in the test suite being defined. As with the test suite, each test case will have its own properties such as “name,” “transport,” “active,” “reboot/re-image required,” “allow concurrency,” etc.

At step 511, the user can determine whether any additional test suites need to be added to the system. If the answer at step 511 is yes, then the process returns to step 503 and is repeated to add additional test suites. If the answer at step 511 is no, i.e., all test suites have been added, processing can proceed to step 513.

At step 513, the user can decide whether any test cycles should be created. While it is possible to directly queue test cases and test suites, it can be beneficial to create test cycles that will allow common groups of test suite configurations to be defined in a single place and reused. If the answer at step 513 is no, i.e., no test cycles are desired, then the existing test suites and/or test cases created in the previous steps can be added directly to the test queue for execution by one or more test devices in the system.

However, if creation of test cycles is desired, i.e., the answer at step 513 is yes, processing can proceed to step 515 to create a test cycle. A test cycle can have properties such as a name, and visibility properties such as publicly visible or publicly editable. These properties can be set at the time of test cycle creation or can be modified later.

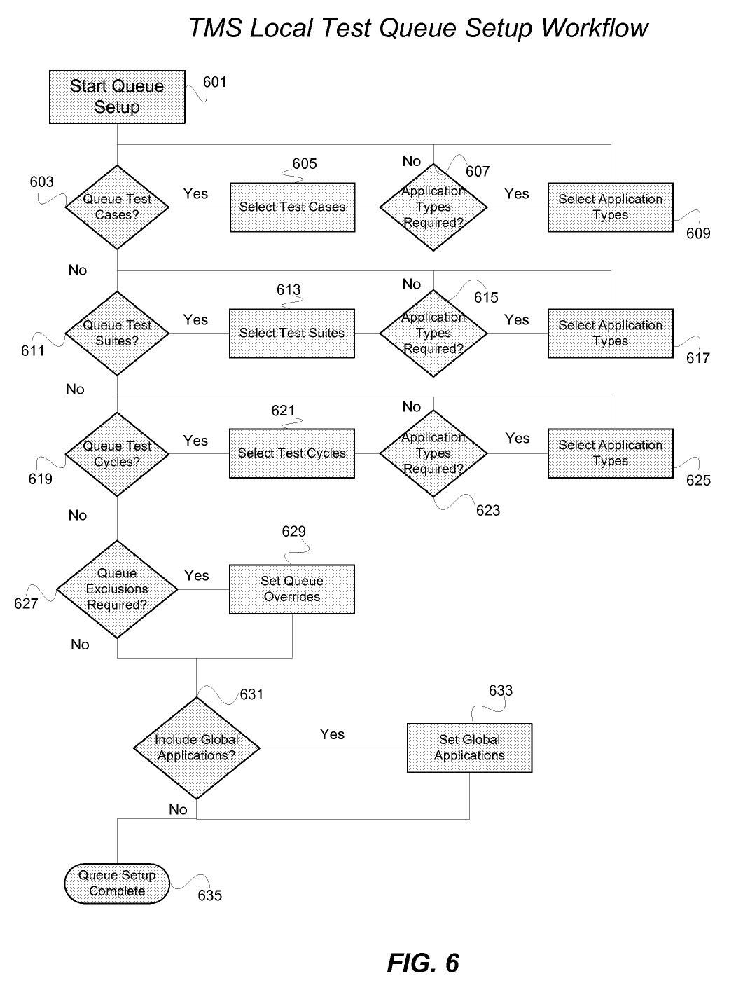

Creation of the test cycle also involves addition of the desired test suites for the test cycle. When each test suite is being added, certain required configurations such as the operating system and language combination to be executed on the test suite can be selected, i.e., by a user via TMS User Interface 301. If the selected test suite had pre-defined any required application types (see, e.g., steps 505 and 507 above) the user can select specific application versions for each of the required types. In addition, when all desired test suites have been added, there can be an option to require an application type, and at step 517, the user can indicate whether the test cycle requires a particular application type to be installed on the test device in order for that test cycle to be executed. If the answer at step 517 is no, processing returns to step 513. If the answer at step 515 is yes, then at step 519, the appropriate application types can be selected by the user and added to the test cycle requirements. Once the required applications types have been added at step 519, or if no application types are required at step 517, processing returns to step 513 to see whether any additional test cycles should be created. Once all desired test cycles have been created, processing then proceeds to step 521 to create a test queue as outlined by the process in FIG. 6

FIG. 6 depicts an exemplary logic flow for set up of a test queue for execution at a local test device in a test management system according to aspects herein. As noted above with respect to the workflow depicted in FIG. 5, the order of steps described herein is merely exemplary, and that other implementations may have other steps or steps performed in another order, and remain within the scope of the present disclosure. In addition, as noted above, many of the steps described herein can be performed by a user by means of a user interface such as TMS User Interface 301.

At step 601, a test server such as TMS Server 301 can set the initial queue properties, for example, queue name, and a scheduled start time if the queue start is to be delayed.

At step 603, a decision can be made whether to queue individual test cases. If the answer at step 603 is yes, then processing can proceed to step 605. At step 605, a test suite can be selected. Individual test cases are then selected from that test suite and an operating system and language selected to create a test configuration for the queue. From step 605, processing then proceeds to step 607, where a check is made to determine if the included test suite has defined application type requirements, as described in FIG. 5 step 507. If the answer at step 607 is yes, processing can proceed to step 609, where specific application versions can be selected for each application type required by the selected test suite. When all application versions have been selected, or if the answer at step 607 was no, then processing returns to step 603 to determine whether any additional test cases are to be included in the queue. If so, processing continues in steps 605, 607, and 609. If not, or if the answer at step 603 in the first iteration is no, processing proceeds to step 611. At step 611, a decision can be made whether to queue individual test suites for execution. If the answer at step 611 is yes, then processing can proceed to step 613, where the individual test suites can be selected, for example, by a user using TMS User Interface 301. The selected test suites can be defined in a manner described above with respect to FIG. 5 and steps 607 and 609 above, with application types being required or not at step 615 and if so, application versions being selected at step 617.

At step 619, a decision can be made whether to queue individual test cycles for execution on a test device. If the answer at step 619 is yes, then processing can proceed to step 621, where individual test cycles can be selected. As with the definition of test suites, the selected test cycles can be defined in steps 623 and 625 in a manner described above with respect to FIG. 5 and steps 607 above.

Once the setup of any desired individual test cycles for inclusion in the test suite is completed, processing can proceed to step 627, where a decision can be made whether to set any queue exclusions, which can globally exclude any already-included tests based on, for example, one or more test properties. If such a global exclusion is desired, i.e., the answer at step 627 is yes, then at step 629, the user interface can display a list of selected test characteristics, such as operating systems, languages, transports, test suites, test groups, application types, and/or applications, that have been selected in any queued test cases, test suites, or test cycles, or can display information regarding test devices such as hardware type, etc. The user may select, for example by using TMS User Interface 301, the types of items which he wishes to exclude from the queue. This is useful because test cycles, and in some cases test suites, may include more tests than are required. For example, a test cycle with 1000 tests may be included; in such a case, the user may wish to exclude only tests that deal with a particular application version with known issues. Alternatively, a test suite could be included and then a user may wish to exclude only the test cases that use a particular connectivity transport. It is also possible to exclude all tests that have known issues, as retrieved from external defect tracking system integration.

In addition, at step 631, the user may also wish to globally include additional applications to be installed for every test case, in addition to those applications already to be installed based on each test suite or test cycle application requirements. If so, processing can proceed to step 633, where TMS User Interface 301 can display a list of all applications, regardless of application type, known by the TMS system. Using TMS User Interface 301, the user may select any applications they wish to have unconditionally installed for every test. This is useful when a user wishes to run existing tests, with their defined applications, with additional applications being installed for compatibility testing to ensure that the existing tests are not broken by the presence of the new application.

Finally, once at least one test case, test suite, or test cycle, has been added and any global exclusions or additions have been configured, at step 635 the test queue setup is complete.

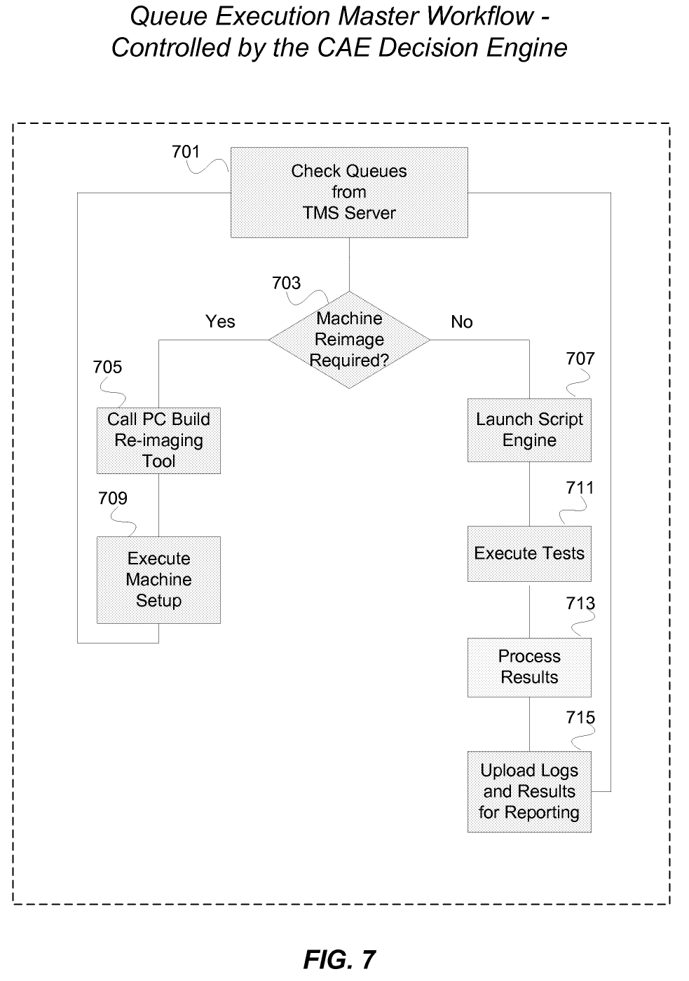

FIG. 7 depicts an exemplary master workflow for test queue execution that can be controlled by the CAE Decision Engine on a test device Thus, as shown in FIG. 7, a master workflow for test queue execution can start at step 701, where a test queue from received from TMS Central Server 201 can be checked, e.g., to determine the system requirements for execution of the tests in that test queue.

At step 703, the CAE Decision Engine determines whether the tests in the selected test queue requires that the test machine be re-imaged or whether the tests can be performed with the machine's existing configuration. If the answer at step 703 is “yes,” then the re-imaging tool, for example, the PC Build re-imaging tool can be called, the setup of the test machine can be executed at step 709, and the process returns to step 701 to check the requirements of the queue again. If the answer at step 703 is “no,” i.e., the test machine does not need to be re-imaged in order to execute the tests in the test queue (for example because it was re-imaged at step 709), at step 707, the script engine is launched, and at step 711 the tests in the test queue are executed, for example, by Test Executor 411E in the TMS Scripting Engine 411.

As each test is executed, the results are processed at step 713, for example, by Logging Engine 411D and/or Validation Engine 411E in Scripting Engine 411. When all of the tests are complete, at step 715, the test logs and results can be uploaded to the TMS Central Server for reporting by Active Data Collector 403E and/or Status Recorder 403G in Client Agent Engine 403. Once a test is complete, the test device can return to step 701 to look for additional tests to perform.

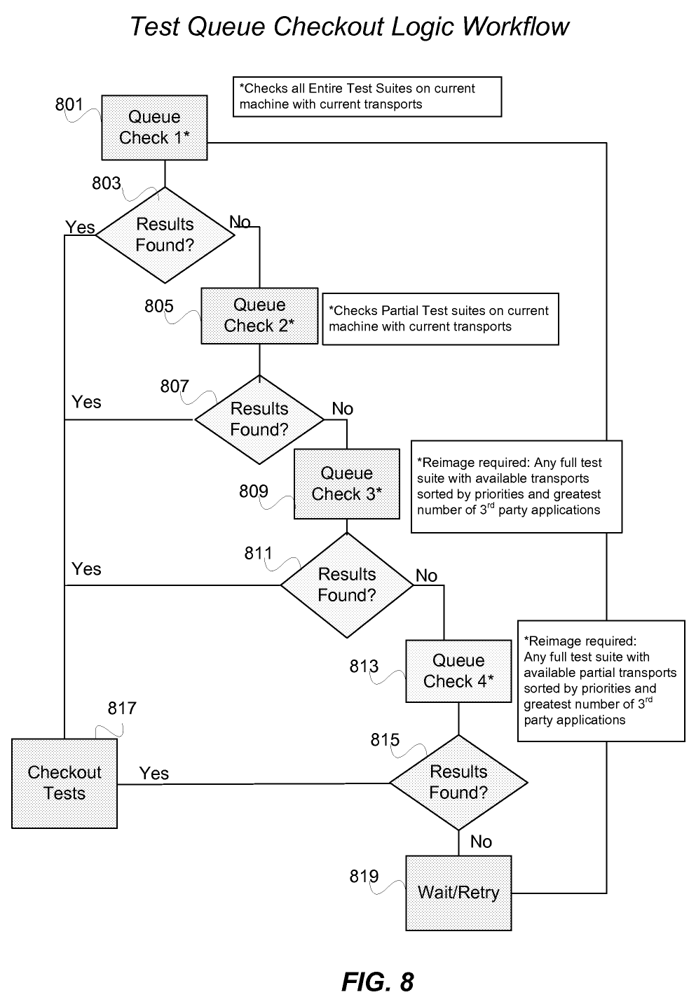

FIG. 8 shows an exemplary logic workflow for a test queue checkout process performed by a test device according to one or more aspects described herein.

Thus, at step 801, CAE Decision Engine 403D on TMS test device 205 performs Queue Check 1 to check whether there are any entire, i.e., complete, test suites that can be executed using the current software, hardware, and device configuration.

At step 803, CAE Decision Engine 403D determines whether there are any such entire test suites. If the answer at step 803 is “no,” then CAE Decision Engine 403D proceeds to step 805 to perform Queue Check 2 to query whether there are any partial test suites can be executed using the current software, hardware, and device configuration. and checks at 807 to see whether the query returns any results.

If the answer at step 807 is “no,” CAE Decision Engine 403D can proceed to step 809 to perform Queue Check 3, and query whether there are any entire, i.e., complete, test suites that can be executed using the current hardware and device configuration after requiring a re-image to a new software configuration. Such a check also can include a check of these test suits by queue priority and/or by the number of third-party applications included in the test suite, and can determine at step 811 whether any such tests are found.

If the answer at step 811 is “no,” CAE Decision Engine 403D can proceed to Queue Check 4 to query whether any partial test suites that can be executed using the current hardware and device configuration after requiring a re-image to a new software configuration; as with the check at the previous step, this check can also include a check of the available tests by test priority and/or the number of third-party applications.

If at step 813 the result of that query is “no,” i.e., there are no such tests in the queue, then at step 817 the test device can wait for some predetermined period of time and then return to step 801 to retry the query process again.

If the answer is “yes” at any of steps 803, 807, 811, and 813, i.e., one or more tests meeting the query criteria is found, then at step 815 the appropriate tests are checked out for execution on the test device. In this manner the test device continually checks to determine whether there are any tests available that the test device can perform, either with its current configuration or with a re-image.

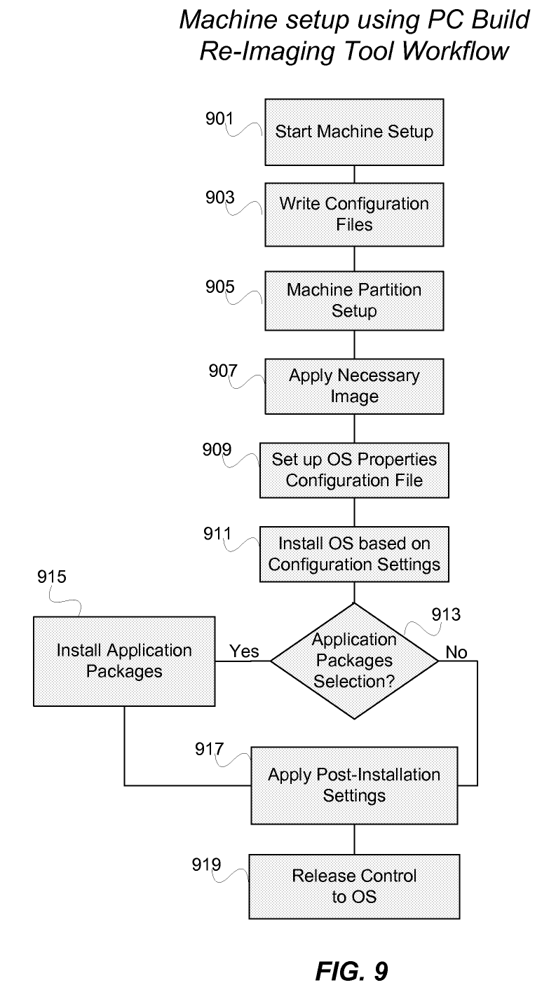

FIG. 9 shows an exemplary workflow for setup of a test machine using a re-imaging tool such as the PC Build re-imaging tool. As described above, a central feature of the Test Management System described herein is the ability of test machines to be re-imaged as needed for any test, with any operating system or applications, so that any test can be run on any machine satisfying a test's hardware requirements without the need for specific devices to be designated for specific tests.

Thus, at step 901, PC Build can begin the test machine setup process. In this step, the re-image configuration can be determined, either by a user making manual selections via the user interface as described above or by the required re-image configuration being passed to the test device by means of the command line.

At step 903, PC Build, for example, by using Favorites Manager 409D, can write any necessary configuration files for the new machine image, for example, by writing a .lastbuild file as described above.

At step 905, any necessary partitioning of the test device can be performed, for example, by Installer Wrapper 409A in PC Build. At step 907, Installer Wrapper 409A in PC Build also can install and apply the machine image that is necessary to run the test scheduled for execution on the test machine. Installation of the image can include setup of a new operating system configuration at step 909, and installation of that new operating system based on the configuration settings at step 911. Installation can also include a determination at step 913 whether the new image involves a selection of any new application packages; if the answer at step 913 is “yes,” at step 915 such new application packages can be installed, for example, by Application Wrapper 409D.

After the new applications are installed, or if the answer at step 913 is “no,” the process proceeds to step 917, where Installer Wrapper 409A can apply any necessary post-installation settings, and then to step 919, where control of the test device is released to the operating system currently running on the device.

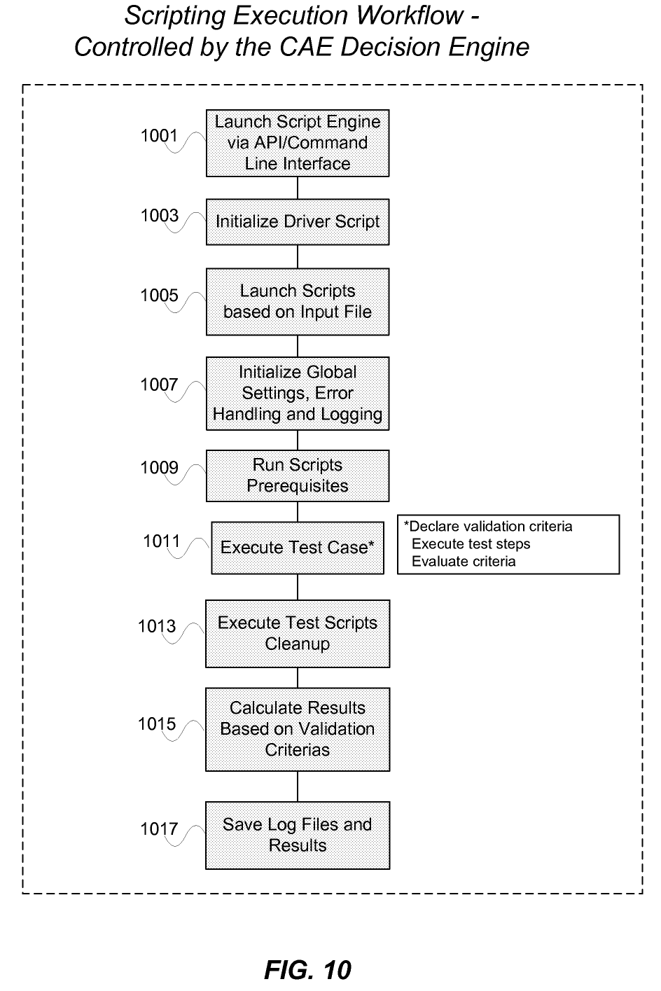

FIG. 10 depicts an exemplary workflow for execution of a test script by the CAE Decision Engine in accordance with one or more aspects described herein. As described above, once the test device has checked the test queue, identified one or more tests for execution, and been re-imaged as necessary, the test device then can execute the one or more tests selected from the test queue.

Thus, as seen in FIG. 10, at step 1001, the test device can launch a scripting engine such as Scripting Engine 411 shown in FIG. 4C via an application programming interface (API) or a command line interface (CLI).

As described above, Application Launcher 403C can write the name of the test case to execute, log level, log file path, and other test case parameters retrieved from Queue Interpreter 403B to an input file for Scripting Engine 411. At step 1003, Scripting Engine 411 can read values from the input file and initialize the driver script and at step 1005 to launch the specified test case.

At step 1007, Scripting Engine 411 can initialize settings for the test, such as global settings applicable to the tests to be run and settings relating to error handling and logging. Once the settings have been initialized, at step 1009, Scripting Engine 411 can run any appropriate scripts prerequisites, such as importing a required registry key, preparing test files within the file system, or restoring default options within the application under test.

Once all the setup and prerequisites have been performed, at step 1011, the test case can be executed on the device, for example, by Test Executor 411E running in Scripting Engine 411, and once the test case has been performed, Test Executor 411E can perform a cleanup of the executed test scripts at step 1013.

Execution of the test can also include substeps such as declaration of validation criteria, evaluation of the test steps, and evaluation of the test against the validation criteria. At step 1015, the results of the testing can be calculated based on validation criteria such as those set up at step 1007, and at step 1017, the log files and results of the testing can be saved for processing by the Active Data Collector 403E and Status Recorder 403G components of the Client Agent Engine 403.

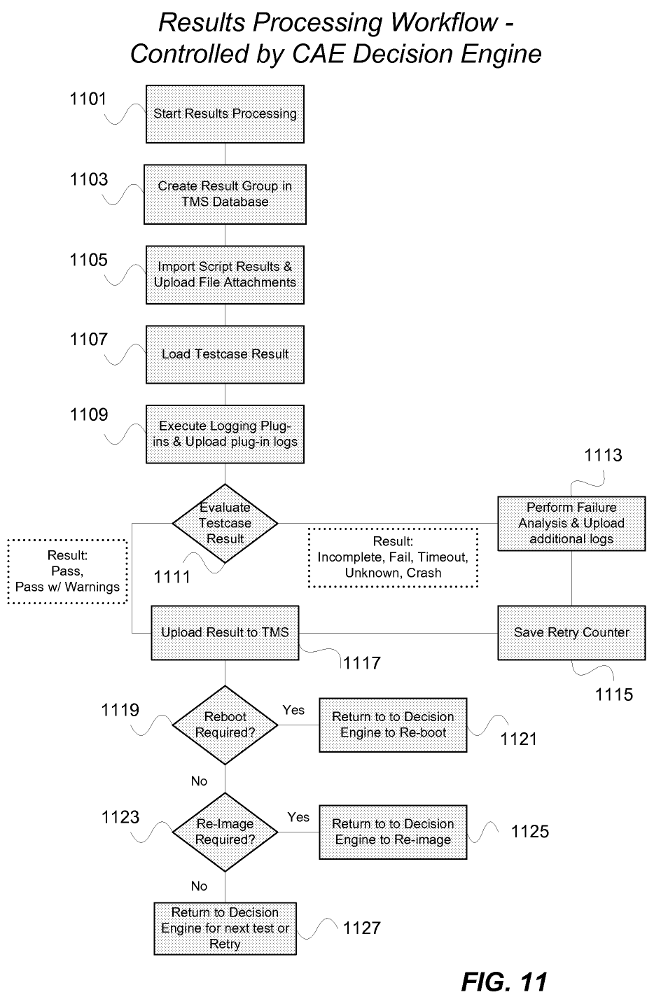

FIG. 11 depicts an exemplary workflow for processing the results of the testing by the Test Management System. In an exemplary embodiment, the steps in the results processing are performed after the steps in the Scripting Execution Workflow shown in FIG. 10 have completed and the Scripting Engine 411 has been closed by CAE Decision Engine 403D. The steps can be performed by the Active Data Collector 403E and Status Recorder 403G components of the Client Agent Engine, as noted below.

At step 1101, the results processing begins. This step is the entry point where the CAE Decision Engine has completed monitoring the scripting runtime and is ready to process the log files

The first step in processing the log files occurs at step 1103. At this step, the scripting engine can create a new result group in TMS Database 201C to store test attempt. This organizes together all the individual log and file attachment entries into an appropriate group.

As described above, during execution of the tests, the scripting engine can generate a logfile (such as an XML file) that contains log, validation criteria, and error entries and also includes information about files that need to be uploaded. This logfile is processed at step 1105. Each log, validation criteria, and error item encountered by the scripting engine encounters can be entered into an appropriate table in the TMS Database 201C. Where appropriate, file attachments also can be uploaded to a networked file share and the TMS database can be updated to include the path to the attachment.

At step 1107, the test case result (pass, fail, incomplete, etc) has already been calculated by the scripting engine's validation engine, for example, Validation Engine 411E, at test case completion, and the result has been written to an input/output file that the Client Agent Engine and the Scripting Engine use to communicate. The Status Recorder 403G loads the result from the aforementioned file, to be processed in subsequent steps.

At step 1109, third party logging plug-ins are initialized. Each plug-in is passed the result from the test case, as loaded in step 1107, and can attach any needed log files generated from the application tested. Different applications will generate different logs. Thus, at step 1109, the scripting engine can send results of the test case to all installed plug-ins and can upload any logs that the plug-ins create. Of course, it is possible that any given logging plug-in may not create any logs.

At step 1111, the results of the test case, as loaded in step 1107, are evaluated. Based on the test case result, one of two branches can take place at step 1111. If the result was a pass or warning, i.e. the Validation Engine 411E processed all validation criteria and all objective criteria passed, processing can proceed to step 1117, where the test case result can be uploaded to the TMS database.

If, however, the result was anything other than a pass or warning, (i.e., incomplete, fail, timeout, unknown, crash) processing proceeds to step 1113. When the test device has not passed the test, a failure analysis can be performed to gather any useful logs. Such failure analysis can incorporate many possible tasks, for example, checking for and uploading crash logs, checking for memory leaks, or stopping processes that failed to complete, etc. In addition, if the test device is in an unstable state, this step may set a flag to indicate a reboot is required, which will be used for cleanup purposes.

After the failure analysis has been performed at step 1113, processing proceeds to step 1115, where a retry counter that is accessible by the CAE Decision Engine 403D is saved. Any test that fails has a limited number of retry attempts. This counter will decrement and eventually reach zero, at which point the decision engine will stop trying to execute the test. In some embodiments, during results processing, the test case properties will be checked to determine if the test case has known issues. If it does, the retry counter will be directly set to zero to abort future retries. Either way, a counter is set with the remaining retries, the test case result and the results of the failure analysis are uploaded to the TMS database at step 1117, and the logic continues to step 1119.

At step 1119, the scripting engine can determine whether a reboot is required. This can be determined in several ways. For example, if the failure analysis performed at step 1113 has determined that a reboot is required, a reboot flag will have set at that step. The processing at step 1119 also can query the test case properties in the TMS database, for example to see if a test case explicitly requires require a reboot and can set the reboot flag. Also, if this was the last test case in the test suite (meaning all checked out tests have been completed including the current test and the retry counter is 0) and the test suite requires a reboot, the completion of the test suite also can set a reboot flag in this step. If a reboot is required, i.e., the answer at step 1119 is yes, processing proceeds to step 1121 where control of the device is returned to CAE decision engine to instruct that the test device be rebooted.

If no reboot is required, processing then can pass to step 1123, where the scripting engine can determine whether a re-image of the test device is required. This can be determined by checking the test case properties to see if a re-image is required after the test case and all test case retries have been exhausted. This also checks to see if all checked out tests have been completed and test case retries have been exhausted, and the test suite requires a re-image.

If a re-image is required, processing can proceed to step 1125, where control of the test device can be passed to the CAE decision engine indicating that a re-image of the device is required, for example, a re-image by PC Build as described above. Assuming that no reboots or re-images are required, at step 1127 control of the test device can return to CAE decision engine as normal. If the result of the test was other than a “pass” result, the test device can retry the test if the retry counter indicates that there are retries attempts remaining. If the test device passed the test or if there are no more retry attempts remaining, the test device can then proceed to the next test case.

Thus, as described herein, a test can be defined at a test management server, placed into a test queue, selected and executed by any test device in the network, and the results processed and uploaded for analysis by enterprise personnel, with minimal user input and no need for pre-configuration or pre-selection of a test device.

Another embodiment of a test management system described herein can be used as part of an SAAS model. Many software companies are moving to a SAAS (Software As A Service) licensing and support model instead of the traditional model of simply selling software. While a sales model typically places the burden of application integration solely on the customer, a SAAS model represents a partnership between the vendor and customer where integration support is expected as part of the service.

Traditional Quality Assurance testing processes have focused on functional testing of an application on tightly controlled sterile device configurations that, while generic enough to represent a reasonable testing baseline, fail to accurately reproduce environments unique to each customer. For example, a customer device may include different hardware, installed applications, or operating system and security settings than are present in a control device. Most significantly, a customer environment will have a different server environment including but not limited to proxy networks, security certificates, VPN servers, network permissibility, and other restrictions not present in a typically open QA environment.

With these differences it is not uncommon for an application to pass testing within a QA environment only to fail when run within a customer environment.

Parts of this solution may be addressed if a customer is willing to deliver their device to the software vendor for testing; however, this option is rarely acceptable to corporations who are unable or unwilling to address complicated security problems inherent with releasing control of a device. In the cases where the vendor is able to obtain customer hardware, any tests performed on such devices will not be representative of testing performed at the customer's site.

An additional embodiment of the test management process could address these concerns by allowing execution of tests in a distributed, multiple site implementation. Following a vendors SAAS model, testing could be included as a service delivered to the customer. Verification of the vendor's applications could be performed, using the vendors automated test management process, on customer devices running tests in the customer environment.

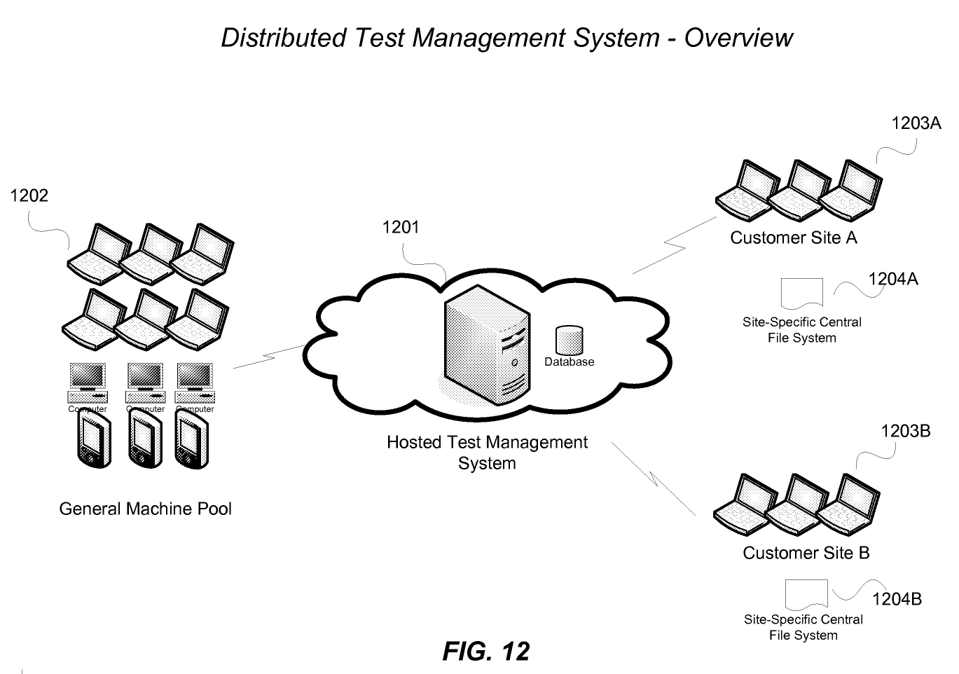

As shown in FIG. 12, a hosted test management system can include a central server 1201 and multiple groups of devices for execution of test cases using the processes described herein. A SAAS vendor could maintain, for testing such as functional testing, a pool of devices such as group 1202. Subscribers to the hosted test management solution could maintain, for execution of test cases within a customer environment, on-site test devices such as those shown in 1203A and 1203B. Each site can maintain a site specific copy of the PC Build File System (FIG. 3B-309) such as examples 1204A and 1204B. Tests scheduled using the TMS User Interface 301 running on a hosted test management server 1201 can be configured to execute on a specific pool of trusted devices.

This embodiment is similar to the previous example with a few exceptions. TMS Central Server 201 could be offered as a hosted solution customers may subscribe to. An implementation of TMS User Interface 301 could include additional permissibility settings that would segregate test cases, test suites, test cycles, queues, results, and other items within TMS Database 201C into user groups allowing each customer, or similar group designation, their own set of test assets. Common assets could, as designated by an administrator, be shared globally across all groups. For example, the core group of test cases may be shared however individual queues and results could be private.

The TMS Database 201C could be extended to include a list of customers. CAE settings file 403A could be extended to include a setting that designates a device as part of a specific customer hardware pool, instead of a global hardware pool. This designation could use a secure method, such as an encrypted authorization key, provided by the SAAS vendor, to ensure each test device is allocated only to an authorized customers test queues. During the initial queue creation step 601, additional options could be added to restrict execution of tests to the customer's specific hardware pool, specific hardware models within the pool, or other criteria. During test execution the CAE Queue Interpreter 403B, could select only tests from the authorized customer's queue.

The PC Build re-imaging tool could use baseline operating system images and third-party application packages that are specifically created and maintained to represent the customer device configuration. In a customer environment the local PC Build Re-Imaging tool file system 405 could be synchronized from a customer central file system 309 instead of the vendor's central file system.

This embodiment would allow tests to execute within a customer environment, on customer devices. A customer could maintain a test lab of their own devices performing validation on their own schedule, with support from a vendor. Other aspects of the embodiment, including test execution and results processing, could be similar to methods previously presented using a hosted server. Results could continue to be stored on a centralized test management server, made available to customers remotely.

Irrespective of the particular embodiment or implementation used, it can be seen that an automated test management systems and methods as described herein can enhance the ability of an enterprise's quality assurance, network development, and information systems personnel to ensure that all systems and devices in the enterprise can function using any combination of the applicable operating systems, applications, versions, and device configurations, thus enhancing the reliability and operability of the enterprise's networks and systems.

It should be noted that aspects of a system and method for automated testing of system configurations and applications on remote devices as described herein can be accomplished by executing one or more sequences of one or more computer-readable instructions read into a memory of one or more computers from volatile or non-volatile computer-readable media capable of storing and/or transferring computer programs or computer-readable instructions for execution by one or more computers. Volatile computer readable media that can be used can include a compact disk, hard disk, floppy disk, tape, magneto-optical disk, PROM (EPROM, EEPROM, flash EPROM), DRAM, SRAM, SDRAM, or any other magnetic medium; punch card, paper tape, or any other physical medium. Non-volatile media can include a memory such as a dynamic memory in a computer. In addition, computer readable media that can be used to store and/or transmit instructions for carrying out methods described herein can include non-physical media such as an electromagnetic carrier wave, acoustic wave, or light wave such as those generated during radio wave and infrared data communications.

Although particular embodiments, aspects, and features have been described and illustrated, it should be noted that the invention described herein is not limited to only those embodiments, aspects, and features. It should be readily appreciated that modifications may be made by persons skilled in the art, and the present application contemplates any and all modifications within the spirit and scope of the underlying invention described and claimed herein. For example, actions relating to the creation, selection, and execution of tests on a test device described herein can be done using any configuration of test server, test device, and any means of selecting or defining tests, applications, versions, parameters, or configurations, with the tests, etc. being limited only by the possible configurations of the system being tested. Such embodiments are also contemplated to be within the scope and spirit of the present disclosure.

What is claimed is:

1. A computer-implemented method for managing selection of a test for execution on a test device in a network, comprising:
receiving information of a test queue comprising a plurality of tests for execution on the test device, each of the plurality of tests having a required device configuration associated therewith;
determining a first device configuration of the test device, the first device configuration being a present configuration of the test device;
querying the test queue to identify a test that can be executed on the test device;
receiving information of an identified first test in the queue that can be executed in its entirety by the test device in the first device configuration; and
receiving information of an second test in the queue that can be executed by the test device in a second device configuration if the identified first test is not present in the queue, the second device configuration being a new configuration of the test device, the second device configuration including at least one of the required operating system, the required language, and the required application of the required device configuration.

2. The method of claim 1, wherein the second device configuration includes at least one of an operating system, a language, and an application different from at least one of an operating system, a language, and an application present in the first device configuration.

3. The method according to claim 1, further comprising:
identifying a component of the first device configuration that is not part of the required device configuration of the downloaded test; and
removing the identified component of the first device configuration;
wherein the test device is reconfigured from the first device configuration to the second device configuration.

4. The method according to claim 1, further comprising:
identifying a component of the second device configuration that is not present in the test device in the first device configuration; and
installing the identified component of the second device configuration;
wherein the test device is reconfigured from the first device configuration to the second device configuration.

5. The method according to claim 1, further comprising:
identifying a component of the first device configuration that is not part of the required device configuration;
identifying a component of the second device configuration that is not present in the test device in the first device configuration;
removing the identified component of the first device configuration; and
installing the identified component of the second device configuration;
wherein the test device is reconfigured from the first device configuration to the second device configuration.

6. The method according to claim 1, wherein each of the plurality of tests in the test queue has a priority associated therewith;
further wherein a higher priority test is identified in response to the query before a lower priority test is identified.

7. A computer-implemented method for managing testing of a test device in a network, comprising:
receiving, at the test device, information regarding a test for execution on the test device, the test having a required configuration associated therewith, the required configuration including at least one of a required operating system, a required language, and a required application;
determining, at the test device, a first configuration of the test device;
determining whether the first configuration of the test device conforms to the required configuration;
automatically reconfiguring the test device to the required configuration if the first configuration does not conform to the required configuration; and
executing the test on the test device.

8. The method according to claim 7, wherein automatically configuring the test device includes:
determining, at the test device, an identity of components of the required configuration;
removing at least one component of the test device's first configuration from the test device;
obtaining at least one component of the required configuration from a data source; and
installing the at least one component of the required configuration on the test device.

9. A computer-implemented method for automatically managing testing in a network, comprising:
creating, at a test management server, a test suite comprising a plurality of test cases, each of the plurality of test cases being configured to test a specified aspect of a test device; and
creating, at the test management server, a test database comprising a plurality of test cycles, each of the test cycles comprising a plurality of test configurations comprising a respective test suite and respective required device configuration of the test device;
receiving, at the test management server, a query of the test database from the test device for one of the plurality of test configurations for execution by the test device, the query including information of a present device configuration of the test device;
returning an answer to the query, the answer comprising a selected test configuration, the selected test configuration comprising a corresponding selected test suite and a corresponding required device configuration; and
transmitting the selected test configuration to the test device for execution, the selected test configuration including components of the required device configuration if the device configuration of the test device does not include all components of the required device configuration.

10. The method according to claim 9, wherein the required device configuration of the test includes at least one of a required operating system, a required language, and a required application.

11. The method according to claim 9, wherein at least one of the test case, test suite, and test configuration is created on a Web-based portal.

12. A computer-implemented method for validating performance of a test device under a test, comprising:
receiving, at the test device, a test script for the test, the test script including information of a predefined validation criterion for the test;
receiving, at the test device, information of a performance of the test device in response to the test; and
applying, at the test device, the validation criterion to the performance information to determine a result of the test.

13. The method according to claim 12, wherein the result of the test includes one of passed, passed with warnings, incomplete, failed, and unknown.

14. The method according to claim 12, further comprising:
determining, at the test device, a next step to be taken based on the result of the test, the next step including one of continuing the test, aborting the test, and modifying the test.

15. The method according to claim 12, further comprising receiving information of a plurality of validation criteria, and further wherein the test device does not pass the test until all the plurality of validation criteria have been evaluated.

16. The method of claim 12, further comprising reporting the result of the test to a central server.

17. A system for automatic end-to-end management of testing of a device in a network, comprising:
a central test management server and a test device connected to the test management server via a communications link;
the test management server including a test management database of test suites, each test suite comprising a plurality of test cases configured to test a specified aspect of a test device, the test management database further comprising a plurality of test configurations; and
the test device including a client agent application configured to determine a current configuration of the test device and to query the test management database for a test configuration for execution on the test device, the query including information of a current configuration of the test device;
wherein the test management server processes the query from the test device and in response to the query returns an allocated test configuration comprising an allocated test suite and information of an associated required device configuration, an identity of the allocated test configuration being based on the current configuration of the test device and the required device configuration; and
wherein the allocated test configuration comprises a first allocated test suite if the current configuration of the test device conforms to the required device configuration; and
further wherein the allocated test configuration comprises a second allocated test suite and at least one component of a required device configuration associated with the second allocated test suite if the current configuration of the test device does not conform to the required device configuration of the second allocated test suite.

18. The system for test management according to claim 17, wherein the client agent application installs the component of the required device configuration to reconfigure the test device; and further wherein
the client agent application executes at least one of the test cases in the second allocated test suite, an identity of an executed test case being based on the device configuration of the test device after reconfiguration.

19. The system for test management according to claim 17, wherein the required device configuration includes at least one of a required operating system, and a required language, a required application.

20. The system for test management according to claim 17, further comprising a Web-based portal, wherein at least one of the test cases, the test suites, and the test configurations is created using a user interface on the Web-based portal.

21. A system for automated end-to-end management of testing of a device in a network, comprising:
a central test management server and a test device connected to the central test management server by a communications link;
the test management server including a user interface, a test management database, a central file system, and a central scripts database; and
the test device including a client agent engine, a test device re-imaging tool, a local file system, a scripting engine, and a local scripts database;
the user interface being configured to receive a selection of at least one of a test case, a test suite, and a test configuration for execution on the test device, each of the test case, test suite, and test configuration having a required device including at least one of a required operating system, a required language, and a required application associated therewith;
the test management database being configured to store information of the at least one test case, test suite, and test configuration therein, the stored information including the associated required device configuration for each test case, test suite, and test configuration;
the central file system being configured to store files of the required operating system, language, and application for each required device configuration and being further configured to communicate with a local file system on the test device;
the client agent engine being configured to select one of the test case, test suite, and test configuration from the test database and being further configured to determine whether a present configuration of the test device conforms to the required device configuration of the selected test case, test suite, or test configuration;
the test device re-imaging tool being configured to re-image the test device according to the required device configuration if the present configuration of the test device does not conform to the required device configuration of the selected test case, test suite, or test configuration, the re-imaging including an installation of at least one of the required operating system, language, and application, the files therefor being transferred from the central file system to the local file system on the test device; and
the scripting engine being configured to execute the selected one of a test case, test suite, test configuration on the test device, a script for the selected test case, test suite, or test configuration being transferred from the central scripts database on the central server to the local scripts database on the test device, the scripting engine being further configured to report a result of the executed test to the test management server;
wherein the test device executes a test from the test management database in accordance with a device configuration of the test device and reports the result of the executed test to the test management server.

22. The system according to claim 21, where the executed test exposes all hardware on the test device to at least one application installed on the test device.

23. A computer program product including a computer storage medium comprising one of volatile media and non-volatile media, and a computer program code mechanism embedded in the computer storage medium for facilitating automated management of testing of a test device in a computer network, comprising:
a computer code device configured to store a plurality of tests in a test queue, each of the plurality of tests having a required device configuration associated therewith;
a computer code device configured to determine a first device configuration of the test device, the first device configuration being a present configuration of the device;
a computer code device configured to query the test queue to identify a test that can be executed on the test device, the query including information of the first device configuration of the test device;
a computer code device configured to identify a first test in the queue that can be executed by the test device in the first device configuration;
a computer code device configured to identify a second test in the queue that can be executed by the test device in a second device configuration if there is not a first test that can be identified;
a computer code device configured to download the identified test from a central server for the test device; and
a computer code device configured to reconfigure the test device from the first device configuration to the second device configuration if the second is downloaded;
wherein the test device can execute the downloaded test.

24. A computer-implemented method for managing testing of a test device in a network, comprising:
storing, at a central test server, a plurality of test queues of tests for execution on a plurality of test devices;
receiving, at the central test server, a query from one of the plurality of test devices for a test for execution on the test device, the query including authentication information regarding one of the test device and a user of the test device;
verifying, at the central test server, the authentication information;
determining an identity of a test queue from the plurality of test queues that contains a test that can be executed on the test device;
determining an identity of a test to be allocated to the test device; and
allocating the identified test to the test device in accordance with the authentication information.

25. The method according to claim 24, wherein at least one of determining the identity of the test queue and determining the identity of the allocated test is based on the authentication information.

26. The method according to claim 24, wherein the authentication information specifically identifies the test device, and further wherein the identified test is allocated to the test device based on the identity of the test device.

27. The method according to claim 24, wherein the authentication information identifies the test device as part of a group of test devices, and further wherein the identified test is allocated to the test device based on the identity of the group.

28. The method according to claim 24, wherein the authentication information comprises a secure authorization key.

29. A computer-implemented method for automatically managing distributed testing on a plurality of test devices in a network, comprising:
creating, at a central test management server, a plurality of test assets, the test assets comprising at least one of a test case, a test suite, a test configuration, a test cycle, and a test queue; and
organizing the plurality of test assets into at least one group in accordance with an organization scheme, the organization scheme further having at least one associated permission;
wherein the test assets can be accessed only in accordance with the permission associated with the group.

30. The method according to claim 29, wherein the organization scheme is based on an identity of at least one user in the network and the test assets can be accessed only by the user.

31. The method according to claim 29, wherein the organization scheme is based on a characteristic of at least one test device in the network and the test assets can be accessed only by test devices having that characteristic.

32. A test management system for managing testing of test devices in a hosted environment, comprising:
a central hosted test management server, the server including a central test database comprising a plurality of tests; and
a plurality of test sites, each of the test sites including at least one test device for execution of tests from the central test database, each of the test sites further including a site-specific central file system for receiving information from the central test database, the information including a plurality of test scripts and build information for reconfiguration of the test device in accordance with a required device configuration associated with at least one of the test scripts;
wherein each of the plurality of test sites is allocated site-specific tests from the central test database based on an identity of the test site;
wherein the test devices in each of the plurality of test sites can be reconfigured in accordance with the required device configuration using information from the site-specific central file system; and
wherein the test devices in each of the plurality of test sites can execute at least one of the plurality of test scripts in the site-specific central file system.
